(19) United States
(12) Patent Application Publication
(10) Pub. No.: US 2025/0118154 A1
(43) Pub. Date: Apr. 10, 2025

(54) ELECTRONIC GAMING SYSTEM FOR PLAYING CARD GAMES WITH MULTIPLE CARD-HANDS

(71) Applicant: Generation Z, LLC, Columbus, MN (US)

(72) Inventors: Stephen Deckoff, Columbus, MN (US); Joshua Gago, Rice Lake, WI (US); Jason Nordby, North St. Paul, MN (US); Lynnette Blom, Brook Park, MN (US)

(21) Appl. No.: 18/905,798

(22) Filed: Oct. 3, 2024

Related U.S. Application Data
(60) Provisional application No. 63/588,087, filed on Oct. 5, 2023.

(51) Int. Cl. G07F 17/32

(52) U.S. Cl. CPC G07F 17/3225; G07F 17/3211; G07F 17/3244; G07F 17/3269; G07F 17/3272; G07F 17/3293

(57) ABSTRACT

Described herein is electronic gaming system using common playing cards that may include player computing devices that provide individualized gaming interfaces for players and a gaming computing device that can: based on sets of playing cards with one set being dealt successive to another set, continuously identify the sets of cards, based on a request from at least one of the player computing devices, identify a first set of playing cards among the sets being continuously identified, identify, among the first set, first and second subsets of cards, transmit, to each of the at least one player device, data representative of the first and second subsets, determine a first count for the first subset and (ii) a second count for the second subset, and determine whether at least one of the first or second count satisfies a gaming rule.

### INCORPORATION BY REFERENCE

This application claims the benefit of priority of U.S. Provisional Patent Application No. 63/588,087, filed Oct. 5, 2023, which is incorporated herein by reference in its entirety.

### TECHNICAL FIELD

This document generally describes devices, systems, and methods related to electronic gaming systems that provide electronic gaming, such as baccarat gaming, using playing cards, such as physical playing cards.

### BACKGROUND

Electronic gaming systems and devices have traditionally relied on random number generators to determine gaming outcomes that are displayed to players as part of the game. Additionally, electronic gaming systems receive player inputs based on the displayed gaming outcomes. For example, while a number of variations exist, electronic gaming devices typically deal a number of cards based on the type of game being played. An outcome of the game (e.g., whether the player won and the odds that apply to the win) may be determined based on a final resulting hand of the player. The player's cards can be determined by the electronic gaming devices using random number generators that are implemented by the electronic gaming devices. Players can play different games but can receive same sets of cards as other players who play different games. The players can also play at different paces relative to each other.

Moreover, baccarat is a game of skill with a large number of variations, including variations in format of game play, player actions (e.g., betting), and determination of gaming outcomes. In general, baccarat games have two hands, a “player” hand and a “banker” hand, on which a player can bet. The player can bet on either of the two hands or a tie between the two hands before cards are dealt for each hand. Each round of play has 3 possible outcomes: the “player” wins because it has a closer score of its card value to a particular value (e.g., a total value of 9) than the “banker” has, the “banker” wins because it has a closer score of its card value to the particular value than the “player” has, or the “player” and “banker” tie. A dealer deals cards for both hands. Two card are dealt to the “player” hand, and other two cards are dealt to the “banker” hand. A point total is determined for each hand based on summating the card values for the hand. For example, 10s and face cards are worth 0 points and all other cards are worth their face value, with Aces being worth 1 point. If a point total is more than 10, the second digit in the point total is the actual value of that hand. To win a bet, the player much place a bet on a hand that totals closer to a value of 9. If in the first 2 cards being dealt, a point total is 8 or 9 for either “player” or “banker,” this is a natural win and the round of play is over; bets that have already been placed are cashed out. If a point value for a hand totals to 8 or 9, then that hand does not receive additional cards. If, on the other hand, the point value for the hand totals between 0 and 5, that hand may receive a hit card, or a third card. Baccarat gaming rules are then used to determine whether the other hand stands with their cards or draws new cards. A winning hand can be calculated once all cards are dealt, the winning hand being the one with a point total closest to 9.

### SUMMARY

The document generally describes electronic gaming systems. More particularly, this document describes electronic gaming techniques for card games (e.g., baccarat games) based on physical cards (e.g., playing cards) dealt at a physical gaming table. The electronic gaming techniques described herein can deal common cards for accommodating multiple players who play the games at different timings and/or paces. For example, sets of cards can be continuously dealt at a physical gaming table (for example by a dealer) at a relatively fast rate or a desired rate. While being continuously dealt, each set of cards can be used for cards being selected and presented to each of multiple players and used for a particular stage of the game being currently played by each of the players. For example, while cards are being continuously dealt at the table, each player can be presented with some or all of the cards that are dealt at a particular moment that the player requests a set of cards, such as when the player starts a new game of baccarat and requests initial first and second hands (e.g., player and banker hands, respectively). As a result, each player can play one or more games at their preferred pace, without being affected by paces and play stages of the other players at the physical gaming table or other players that are remote from the physical gaming table.

In general, a game of baccarat traditionally involves dealing cards to first and second hands (e.g., “player” and “banker” hands) at a table, which players at the table can then place bets/wagers on. Card-based electronic gaming systems for baccarat can be programmed to continuously deal common cards used by all players playing at the particular table, including players who are playing virtually or otherwise remote from the particular table. Card-based electronic gaming systems for baccarat can also be programmed to allow the players at the table (and remote from the table) to play the game at their desired paces, without having to rely on timing of other players playing the game. For instance, in one example of a baccarat game provided with common cards via a dealer-assist electronic gaming system, a dealer can physically deal five cards (e.g., scan five physical cards from a deck/shoe of cards). For players who start the game at a same time, the system reads and applies a subset of the dealt cards as initial first and second hands (e.g., player and banker hands) for those players at a table (physical and/or virtual table) or who are playing using remote computing devices (e.g., mobile devices remote from the table). The initial first and second hands can be the same for each player who starts the game or otherwise requests cards at a same time. At the same time, for players who have already started the game earlier (and thus are in the middle of the game), the system can apply a subset of the dealt cards as a hit card for at least one of those players' first and second hands, according to baccarat gaming rules. The subsets of dealt cards can be presented on displays for each player (e.g., display equipment embedded in/attached to a gaming table, mobile display equipment), but can be used for different purposes, namely as the initial first and second hands for players who just started the game, or as at least one hit card for players who are in the middle of the game, have placed bets on either of the first and second hands, and/or have first and second hands that are neither winning nor tied, according to baccarat gaming rules.

The dealer can continuously deal sets of cards that are physically drawn (from the deck/shoe) by the dealer, read by the system, and applied across the players' hands that are at different stages of the game. Physically dealt cards in a set can be alternatively assigned to each of the hands in a game of baccarat. In one example, a first drawn card in a set of physically dealt cards can be assigned as a first card in the initial first hand (e.g., player hand), a second drawn card in the set can be assigned as a first card in the initial second hand (e.g., banker hand), a third drawn card in the set can be assigned as a second card in the initial first hand, and a fourth drawn card in the set can be assigned as a second card in the initial second hand. A fifth drawn card in the set can be ignored or otherwise discarded (and therefore not used in any subsequent set of physically dealt cards). Any of the first and second hands that requires a hit card based on baccarat gaming rules can be assigned one of first 2 drawn cards in a next set of cards that is dealt by the dealer. If neither hand requires a hit card, gaming outcomes can be determined and winning bets can be paid out. If, on the other hand, one of the first and second hand requires a hit card according to baccarat rules, a first drawn card in a next set of cards that is dealt by the dealer can be assigned as the hit card for that hand.

In addition to a main game (e.g., baccarat) being played, the sets of cards being continuously dealt can also be used for a variety of side bets. Side bets are bonus bets placed on a round of baccarat on outcomes beyond whether a next round will be won by either hand or there will be a tic. Side bets can be staked at the start of a round of baccarat along with main bets/wagers, before cards are dealt. Many side bets also can have fixed odds that may offer greater payouts than the up to 8:1 available for any regular bet. The players can place side bets on top of existing wagers or bets that they placed during a game. Side bets can be based on one or more card combinations. For example, a side bet for a 3 card “8” on the initial first hand (e.g., a player hand in baccarat) can pay a side bet 25 to 1, or something similar. One or more other side bets that can be placed in baccarat include, but are not limited to, combined value bets, Bellagio Match, Super 6, 3-Card Six, 4-5-6, Royal Match, Either Pair, Perfect Pair, Rabbit Play, Egalite Bets, All Red/Black, First Two Cards Same Suit, Unlucky 8, Lucky 8, Double 8, Dragon Bonus, Dragon 7, Matching Dragon, Panda 8, and Quik. Even more possibilities may arise for placing side bets.

One or more embodiments described herein can include an electronic gaming system using common playing cards. The system includes a plurality of player computing devices that are configured to provide individualized gaming interfaces for a plurality of players; and a gaming computing device that is in communication with the plurality of player computing devices, the gaming computing device configured to: based on a plurality of sets of playing cards with one set of playing cards being dealt successive to another set of playing cards, continuously identify the plurality of sets of playing cards; based on a request from at least one of the plurality of player computing devices, identify a first set of playing cards among the plurality of sets of playing cards being continuously identified; identify, among the first set of playing cards, a first subset of cards and a second subset of cards; transmit, to each of the at least one of the plurality of player computing devices, data representative of the first and second subsets of cards; determine (i) a first count for the first subset of cards and (ii) a second count for the second subset of cards; determine whether at least one of the first count or the second count satisfies a gaming rule; and return, to each of the at least one of the plurality of player computing devices, a result, the result including a determination of whether at least one of the first count or the second count satisfies the gaming rule.

In some implementations, the embodiments described herein can optionally include one or more of the following features. For example, the electronic gaming system includes a plurality of physical playing cards that are physically dealt by a dealer; a scanner that is configured to identify each of the playing cards as they are dealt by the dealer, wherein the scanner is in communication with the gaming computing device; and a plurality of gaming tables, wherein each of the plurality of gaming tables allows the dealer to deal the physical playing cards, wherein the scanner is configured to read one or more of the physical playing cards for the gaming table. At least one of the plurality of player computing devices may be physically located at at least one of the plurality of gaming tables. At least one of the plurality of player computing devices may be physically remote from a location of at least one of the plurality of gaming tables. The gaming computing device may be configured to deal the playing cards. The first subset of cards may represent a first player hand and the second subset of cards represents a second player hand. The result may include a payout to each of the at least one of the plurality of player computing devices, wherein the gaming computing device is further configured to: receive, from each of the at least one of the plurality of player computing devices, a bet on the first and second subsets of cards; and determine the payout for each of the at least one of the plurality of player computing devices based on the respective bet and the determination of whether at least one of the first count or the second count satisfies the gaming rule. The gaming computing device may be configured to transmit information to present, in graphical user interface (GUI) displays of the at least one of the plurality of player computing devices, graphical elements for placing one or more bets on the first and second subsets of cards. The one or more bets may include at least one of betting that the first subset of cards wins, the second subset of cards wins, and the first and second subsets of cards are tied. The gaming computing device may be configured to receive, from each of the at least one of the plurality of player computing devices, the bet before identifying the first and second subsets of cards. The gaming computing device may be configured to receive, from each of the at least one of the plurality of player computing devices, the bet before transmitting, to each of the at least one of the plurality of player computing devices, the data representative of the first and second subsets of cards. The gaming computing device may be further configured to: start a timer for a threshold period of time during which the gaming computing device receives bets from the at least one of the plurality of player computing devices; and based on the threshold period of time expiring, stop the timer and transmit, to each of the at least one of the plurality of player computing devices, the data representative of the first and second subsets of cards. The result may indicate at least one of: (i) the first subset of cards satisfies the gaming rule, (ii) the second subset of cards satisfies the gaming rule, (iii) the first count and the second count are tied. The result may indicate a payout to each of the at least one of the plurality of player computing devices based on the determination of whether at least one of the first count or the second count satisfies the gaming rule. The gaming computing device may be further configured to, based on at least one of the first count or the second count satisfying the gaming rule: identify, among a second set of playing cards among the plurality of sets of playing cards, at least one hit card, wherein the at least one hit card is added to at least one of the first subset of cards and the second subset of cards; and transmit, to each of the at least one of the plurality of player computing devices, data representative of the at least one hit card. The gaming computing device may be further configured to: update, according to the gaming rule, at least one of the first count or the second count of the at least one of the first subset of cards and the second subset of cards that is assigned the at least one hit card; and determine whether the at least one of the updated first count or the updated second count satisfies the gaming rule. The playing cards may be physical playing cards and the gaming computing device may be configured to translate the first set of playing cards into a first set of electronic cards at a first time and translate the second set of playing cards into a second set of electronic cards at a second time, wherein the first time is before the second time. The at least one hit card may include a first card and a second card in a card sequence in the second set of playing cards. The gaming computing device may be further configured to discard third, fourth, and fifth cards in the card sequence in the second set of playing cards. The discarded second, third, fourth, and fifth cards may be not used in subsequent sets of the playing cards. The first set of playing cards may be different than the second set of playing cards. The gaming computing device may be further configured to return results indicating that the first subset of cards or the second subset of cards wins based on the respective first count or the second count being within a threshold range from a predetermined numeric value. The predetermined numeric value may be 9. The gaming computing device may be further configured to determine a payout for each of the at least one of the plurality of player computing devices based on at least one of the first subset of cards or the second subset of cards winning. Each of the at least one of the plurality of player computing devices may be configured to output, in response to receiving the data representative of the first and second subsets of cards, graphical representations of the first and second subsets of cards in a GUI display at the player computing device. The first set of playing cards may include five cards. The first subset of cards may include first and third cards in a card sequence in the first set of playing cards, and the second subset of cards may include second and fourth cards in the card sequence in the first set of playing cards. The gaming computing device may be configured to discard a fifth card in the card sequence in the first set of playing cards. The discarded fifth card may be discarded from subsequent sets of playing cards. The first and second subset of cards may be identified based on one or more card identification rules. The gaming rule may include at least one rule for playing a game of baccarat. The gaming computing device may be further configured to receive, from at least one of the at least one of the plurality of player computing devices, data representative of a side bet; and determine one or more gaming results for the at least one of the at least one of the plurality of player computing devices based on the side bet. Sometimes, the gaming computing device can also provide, in GUI displays of the at least one of the plurality of player computing devices, selectable options to play multiple different games simultaneously with the first or second subsets of cards.

The devices, system, and techniques described herein may provide one or more of the following advantages. For example, the disclosed techniques reduce costs of labor to operate casinos and other gaming environments. Since the disclosed technology allows for continuously dealing for multiple games from one set of cards (e.g., by a dealer at a gaming table and/or by a gaming computing system), less human labor is required to operate the multiple games. One dealer, for example, can deal for and monitor multiple games at once from one gaming table and/or one gaming computing system. Less human labor involved can also improve efficiency and accuracy of gameplay in the multiple games by reducing potential human error in determining gaming outcomes and gaming rules. Less human labor involved can also reduce training or other onboarding costs for the casinos or other gaming environments that employ the disclosed technology.

Similarly, the disclosed technology also improves payout accuracy by reducing human error. In various betting games, payout schemes can be different and/or challenging to memorize and learn for a human dealer. The digital payout format of the disclosed technology avoids time, resources, and cost of training human dealers to learn all the rules of various different games and their respective payout schemes. This improves accuracy of game dealing, outcome, and payout decisions.

As another example, the disclosed technology provides increased game offerings to players. Players can play a variety of different games from their single player computing device, regardless of whether there is sufficient resources (e.g., gameplay space, chip sets) to offer a full-sized game at a gaming table. The players can play the variety of games simultaneously, by toggling between graphical user interface (GUI) displays presented at their respective player computing devices during gameplay. The GUI displays can provide easy, interactive, and user-friendly experiences that encourage the players to play multiple games at once.

Table-based card games can therefore be provided to a large number of players from a single table. Traditional table games have a limited number of seats available for players. In contrast, electronic gaming systems that use common cards that are being continuously dealt can allow participation of players at the physical table where the cards are being dealt as well as players who are remote from the table and/or connected to the table virtually, and allow players to participate in the game at different times and play at different paces. This can expand the number of players (beyond just those seated at the physical table) for a single table to include a large number of players who may be playing remotely from a location within a gaming environment (e.g., casino, card club, race track) and/or over the internet. Additionally, the number of players can be expanded without concern for the ratio of players to remaining cards in a deck/shoe. Using the disclosed technology to reduce resources, both physical (in terms of cards and dealer time to deal out each hand) and electronic (in terms of computing resources used to process game play, such as processor cycles, memory, network traffic, etc.), can make gameplay more efficient and faster. Additionally, even though the disclosed technology provides greater efficiencies, it still permits each player to individually make moves (e.g., place bets, start new games, play multiple games at once) regardless of whether they are seated at the physical table or remote, which can improve player engagement while maintaining gaming efficiencies.

The disclosed technology provides for simultaneously managing each player's gameplay in the variety of different games in real-time, such as based on timing at which they take action(s) in each game, gaming rules, gaming outcomes, payout determinations, betting actions, side betting actions, etc., The disclosed technology is able to manage such gameplay not only for any quantity of games played by a single player, but also any quantity of games being played by any quantity of players, including players who are physically located in a casino or gaming environment and players that are remote from such location(s) but playing the variety of different games remotely at their respective player computing devices. Consequently, more players can play games without being constrained by physical limitations of casinos, other gaming environments, and/or specific game-based limitations (e.g., a number of players who can play a particular game, a number of players who can sit at a physical gaming table).

Likewise, the disclosed technology provides for players to play at their own paces without compromising any player's gameplay. A dealer can continuously deal physical cards at a table at different time intervals. Players, both at the table and remote from the table, can perform actions on their hands, such as placing bets or starting new/additional games, at different times, and the dealer at the table does not have to wait for all the players to perform the actions to move on to a next stage of gameplay. When a player performs an action such as placing a bet on a hand in a game of baccarat, a request can be transmitted to the dealer's computing system for a determination of whether the player wins the bet based on the cards in the hand. The dealer's computing system can make this determination at a same or similar time as a time of the request. Thus, a fast player may not be held up waiting for a determination of whether they win their bet because of a slower player at the table or remote from the table. Each player can play at their desired paces, regardless of the paces of other players.

Similarly, the disclosed technology provides for higher earn rate per table per day in a gaming environment. Since multiple games are offered with a same dealer at a gaming table, a frequency of players at that table playing games, whether the players are physically present or physically remote at the table, increases. Higher frequency of play increases an amount of money cycling through the table, thereby improving profits on the house.

In another example, by using common cards instead of individual cards, a number of cards that are used for multiple players can be decreased, which can create greater efficiencies, increase the number of players that are able to play per shoe, and decrease the amount of time that is spent switching between/shuffling shoes. Thus, the amount of time taken away from game play (due to shoe shuffling/replacement) can be reduced, the electronic and physical resources that are allocated per player can be reduced, and the amount of time dedicated to game play can be increased.

As another example, electronic baccarat gaming can be provided in jurisdictions (e.g., cities, counties, states, countries) that prohibit gaming outcomes based on random number generators and pseudo-random number generators. Electronic baccarat gaming, like electronic baccarat equipment, may rely on computer-based random number generators and pseudo-random number generators to electronically determine which cards are dealt to players. Some jurisdictions prohibit the use of random and pseudo-random number generators to determine gaming action and outcomes-meaning that in those jurisdictions, conventional electronic baccarat gaming is prohibited in gaming environments. By providing baccarat with common cards that are continuously dealt with dealer-assist electronic gaming systems, electronic baccarat gaming can be provided to players in these jurisdictions that prohibit random and pseudo-random number generators because the gaming action and outcomes are determined by physical cards that are physically dealt by a dealer.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-B are conceptual diagrams of an example card-based electronic baccarat gaming system.

FIGS. 2A-B are conceptual diagrams of an example card-based electronic gaming system that can be used for the baccarat game of FIGS. 1A-B.

FIG. 2C is a conceptual diagram of timing for example gameplay with the card-based electronic gaming system of FIGS. 1A-B and 2A-B.

FIGS. 2D-E are conceptual diagrams of the example card-based electronic gaming system of FIGS. 1A-B and 2A-B.

FIGS. 3A-B depict example game play using cards that are continuously dealt with an example card-based electronic baccarat gaming system.

FIG. 4 depicts an example grid of continuously dealt playing cards.

FIGS. 5A-B is a flowchart of an example technique for performing card-based electronic baccarat gaming.

FIG. 6 is a flowchart of another example technique for determining gaming outcomes for multiple games that are simultaneously played as cards are being continuously dealt.

FIGS. 7A-C are flowcharts of example techniques for transmitting sets of cards to player computing devices.

FIG. 8 is a schematic diagram that shows an example of a computing device and a mobile computing device.

Like reference symbols in the various drawings indicate like elements.

### DETAILED DESCRIPTION OF ILLUSTRATIVE EMBODIMENTS

This document relates to electronic gaming systems and continuous progression of gameplay regardless of pacing and/or stages of gameplay of each player at a physical gaming table or remote from the gaming table. Although the disclosed technology is described in reference to baccarat games, the disclosed technology is also applicable to a variety of other types of games provided by electronic gaming systems, including but not limited to five-card draw poker games, roulette, and craps. When multiple players are involved, each player can play a game at different paces. For example, some players can leave the game and come back to it at a later time. Other players can focus only on one game and can make quick gameplay decisions that cause them to play the game relatively faster than other players. The disclosed technology provides for allowing players to play at their desired paces without being slowed down or pressured to play faster by other players. As described herein, a dealer can continuously deal sets of cards that can be ready the moment they are dealt to be transmitted to electronic gaming equipment of one or more players. For example, some players can start a game of baccarat at the same time and can all receive a same set of cards for initial first and second hands. A first player can place a bet on at least one of the initial first and second hands. Data representative of the first player's bet can be transmitted, by the player's computing device to the electronic gaming system, and used by the electronic gaming system to determine an outcome of the game for the first player and/or whether one or more of the first and second hands satisfy baccarat gaming rules and therefore should receive a hit card. A second player can take a longer amount of time to place bets and therefore the second player's computing device can transmit data representative of the second player's bet(s) at a second time that is later than the first time. The first player can receive whatever set of cards (e.g., at least one hit card) were dealt at or around the first time while the second player can receive whatever set of cards (e.g., at least one hit card) were dealt at or around the second time. The two players can then continue to play the game at their desired paces without being held back or speeding up to maintain a similar pace of gameplay as each other. Further, some players can join and start their games at any later time while other players are already in their games at their own paces.

Moreover, the gaming systems described herein can allow players to play side bets. The players can place side bets on top of existing wagers or bets that they placed. Several types of side bets can be added to a baccarat game that is primarily described therein. Side bets can be based on one or more card combinations. For example, a side bet for a 3 card “8” on the initial first hand (e.g., a player hand in baccarat) can pay a side bet 25 to 1, or something similar. Even more possibilities may arise for placing side bets when dealing cards on a twenty-five card grid or another grid structure that is described herein.

In addition, the gaming systems described herein can allow players to tip dealers to reimburse or otherwise reward the dealers for a positive gaming experience. For example, the players can make straight donations to the dealers using one or more options that are presented on player computing devices. The players can also tip the dealers in the form of betting for the dealer, along with the players' hands.

This document describes a variety of different features, which can be selected and incorporated into gaming systems and equipment in various combinations. For example, different jurisdictions can have different gaming regulations outlining gaming features that are permitted within the jurisdictions. Features that are compliant with the gaming regulations for a jurisdiction can be implemented (e.g., activated, included) in gaming systems and equipment deployed in that jurisdiction, and other features that are not permitted within the jurisdiction can be deactivated/not included.

The disclosed technology is described herein as applying to card-based electronic baccarat games. Baccarat is a game having 3 possible outcomes: a first hand (e.g., player hand) wins, a second hand (e.g., banker hand) wins, or the first and second hands tic. Players in a game of baccarat have the option to bet on either the first hand or the second hand, or a tie between the first and second hands. Bets can be place on the first hand, the second hand, or the tie before cards are dealt. For example, players can place bets before two cards are drawn for each of the initial first and second hands. As another example, players can place bets before at least one hit card is drawn for at least one of the first hand and the second hand. As mentioned above, two cards are dealt to each of the first and second hands. Traditionally, a dealer operating a shoe slides one card out and places it face up in a first hand box on a baccarat table. A next card is then placed face up in a second hand box on the baccarat table. The dealer then deals another card for the first hand and another card for the second hand.

Next, the dealer traditionally announces point totals for both sets of first and second hands. 10s and face cards are worth 0 points. All other cards are worth their face value, with ace being worth 1 point. If a total for one of the first and second hands is more than 10, the second digit in the total is used as the point total for that hand. For example, a 9 and a 6, which totals 15, makes up a 5-point hand. For a player to win, their bet must be on a hand that totals closer to 9. If in the first two cards that are dealt, a point total is 8 or 9 for either the first hand or the second hand, this is a natural win and the game is over. Bets that were already placed are paid out. However, in a game of baccarat, traditionally the dealer determines whether the first hand (e.g., the player hand) should receive a third card, or a hit card, based on the point totals. The first hand is completed first. A total of 8 or 9 for the first hand will get no additional cards, or hit cards. The first hand also stands on totals of 6 or 7. On any other total between 0 and 5, a hit card is drawn as a third card for the first hand, unless the second hand (e.g., the banker hand) has a total of 8 or 9, in which case the second hand winds with no further draw.

If the first hand stands (or draws no new cards), the second hand draws with a hand total of 0 through 5 and stands with a hand total of 6 or 7. All other hands may be dependent on the third card, or the draw card, dealt to the first hand. For example, if the first hand's third card is 9, 10, face or ace, the second hand draws when it has a 0 through 3 total, and stays if it has a 4 through 7 total. If the first hand's third card is 8, the second hand draws when it has a total between 0 and 2, and stays with a total between 3 and 7. If the first hand's third card is 6 or 7, the second hand draws when it has a total between 0 and 6, and stays when it has a total of 7. If the first hand's third card is 4 or 5, the second hand draws when it has a total between 0 and 5, and stays when it has a total between 6 and 7. If the first hand's third card is 2 or 3, the second hand draws when it has a total between 0 and 4, and stays with a total between 5 and 7. One or more other baccarat gaming rules may be used to govern the third card, or hit card, for the second hand.

Once all the cards have been dealt for the first and second hands, a winning hand is calculated. The winning hand is that which totals closer to 9. In the event of a tie, neither hand wins or loses (while a player betting on a tie wins). Sometimes, a commission may also be paid out of winnings when betting on the second hand.

The disclosed technology provides for automating traditional baccarat gameplay such that players can play same or different games at their desired paces and/or from their desired locations (e.g., physically at a table where the dealer is dealing the cards or physically remote from the table or a gaming environment/facility having the table). By automating baccarat gameplay in an electronic gaming system, gaming outcomes can also be determined efficiently and accurately.

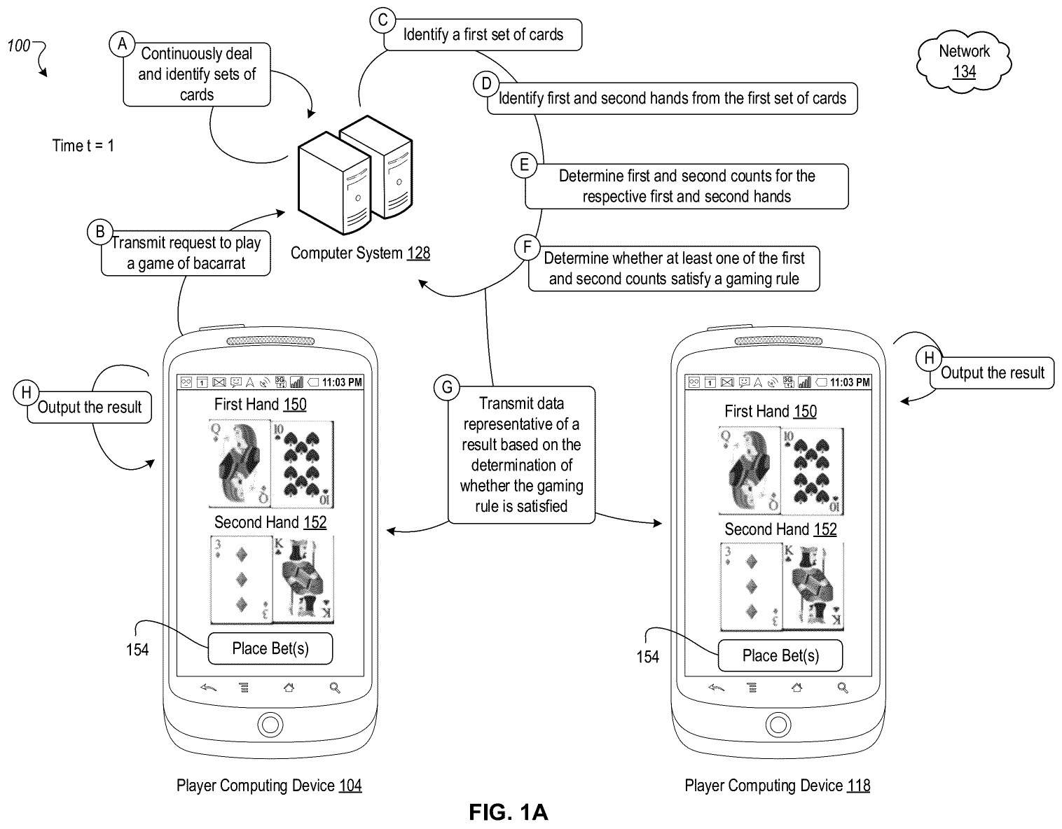

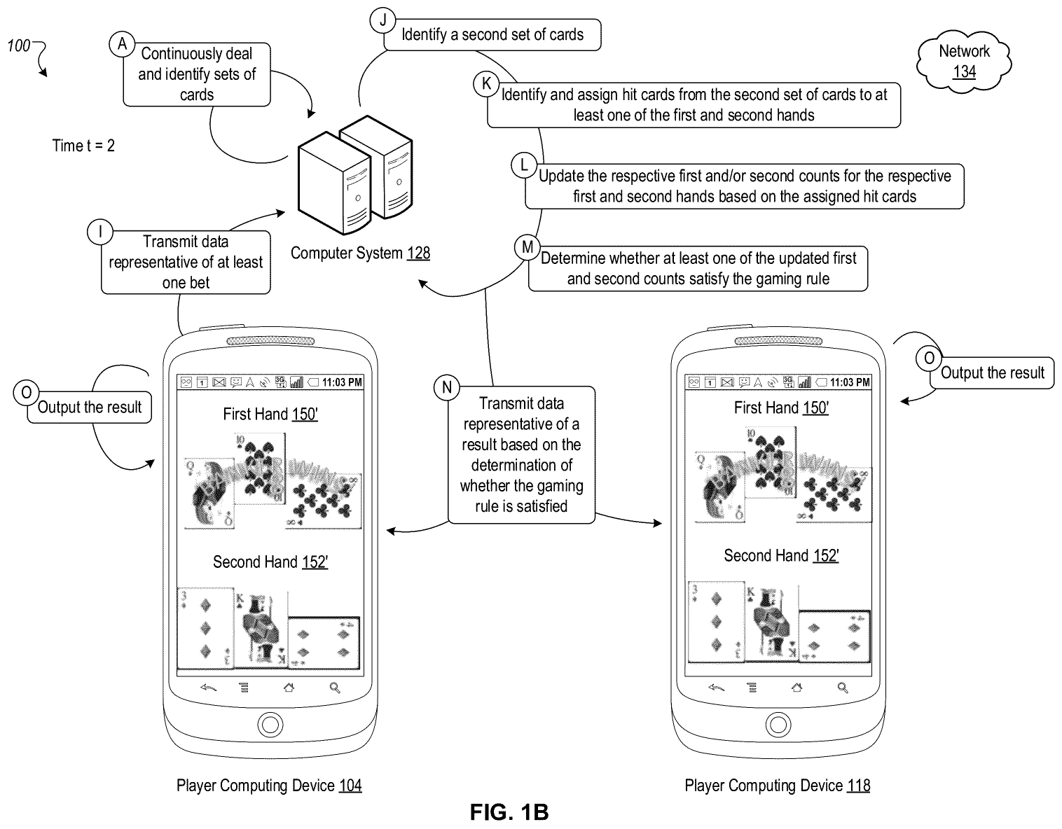

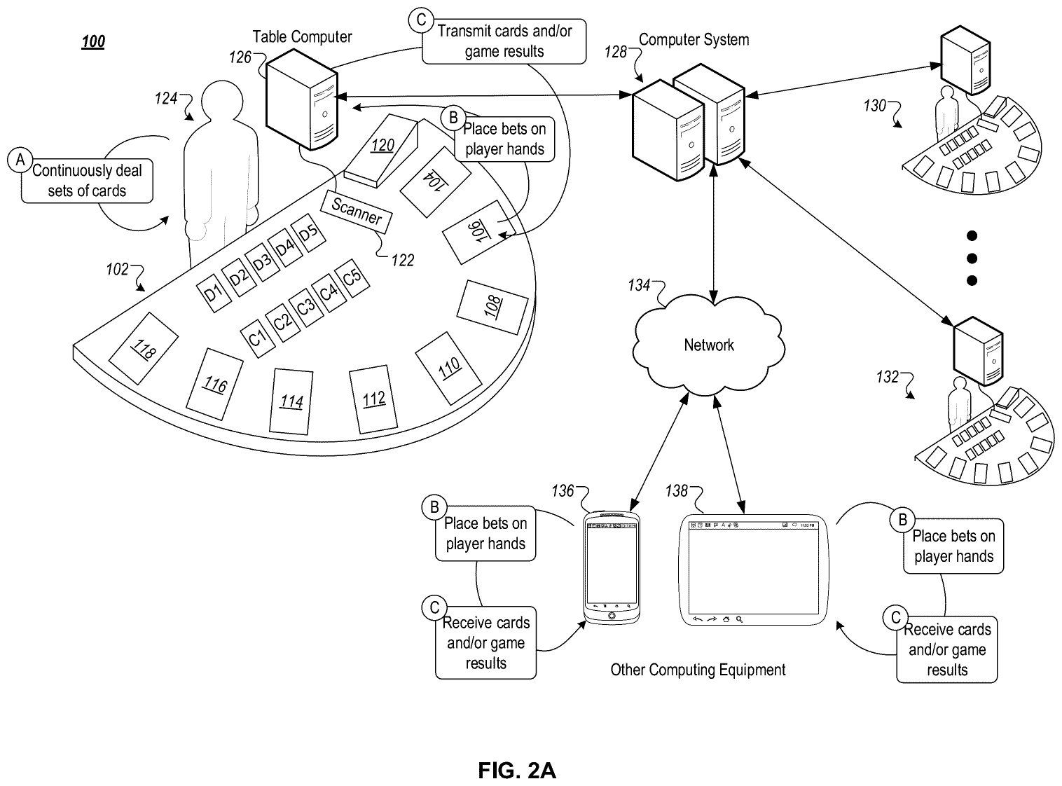

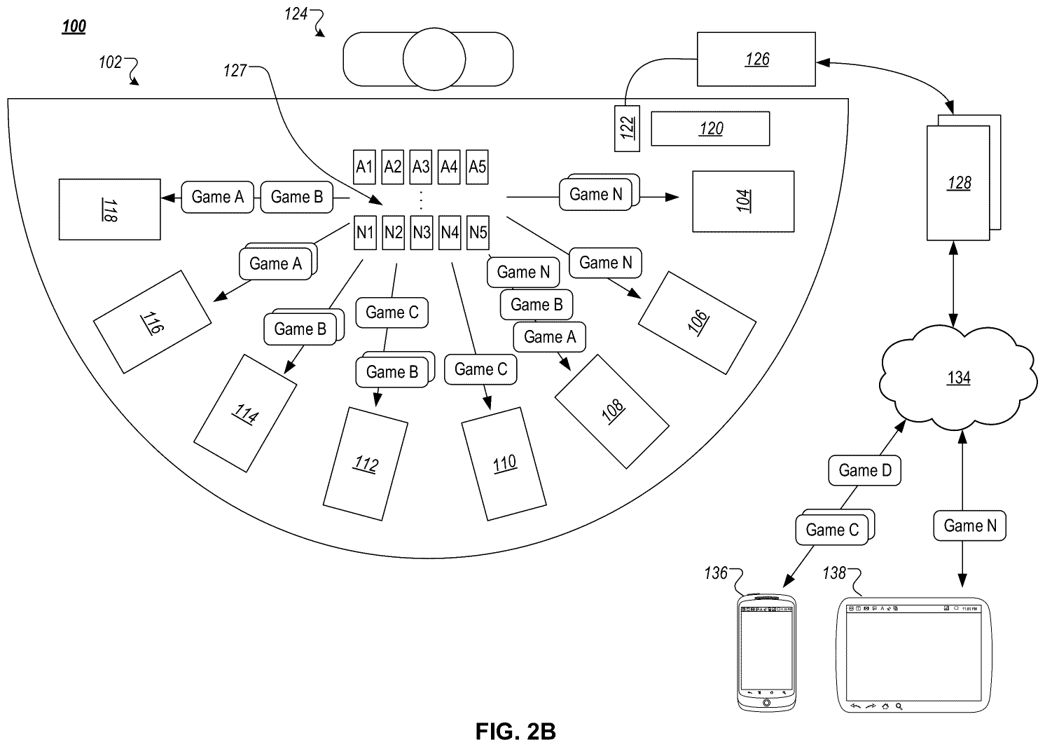

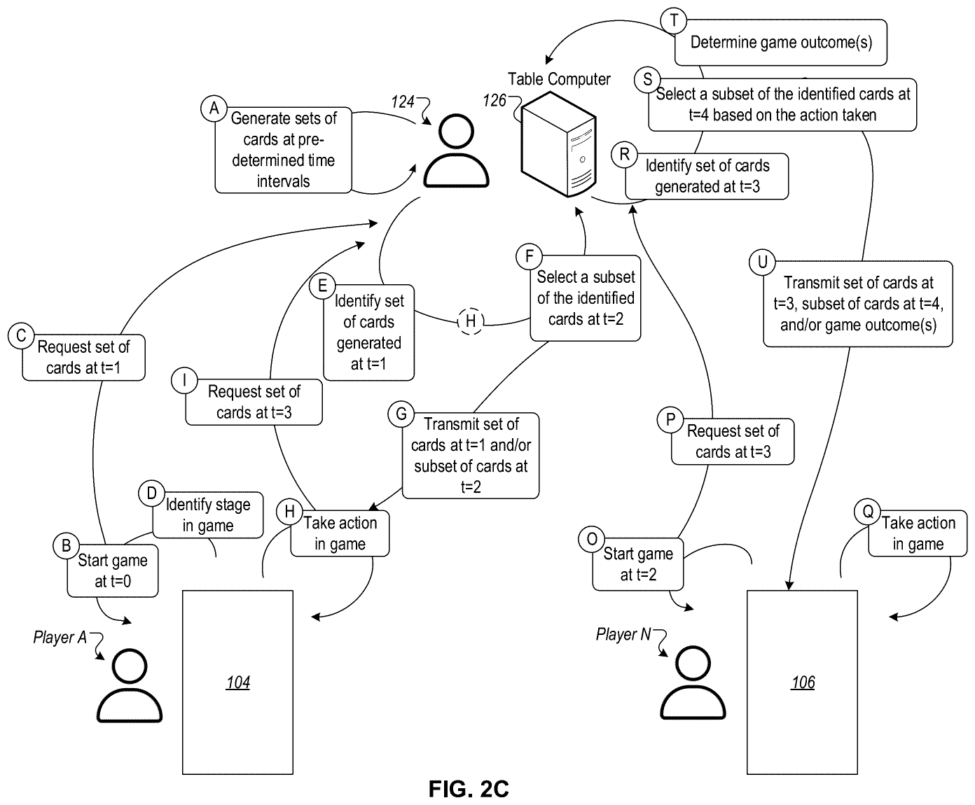

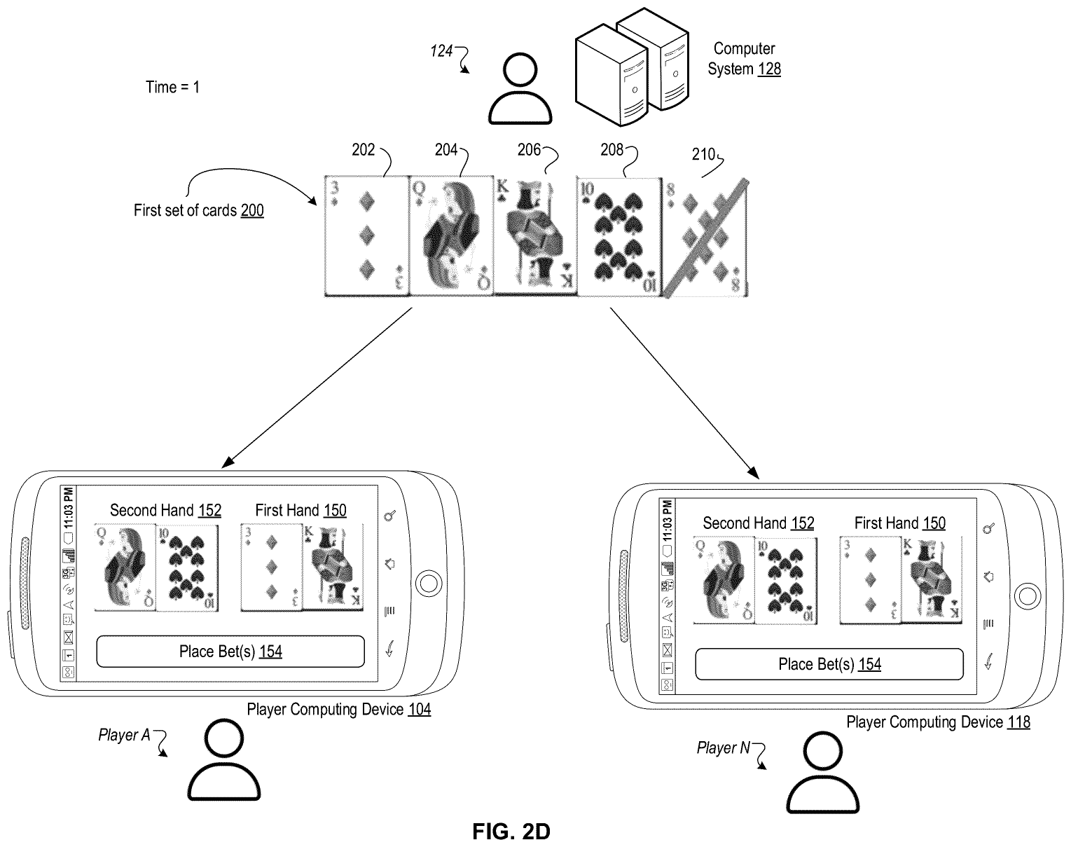

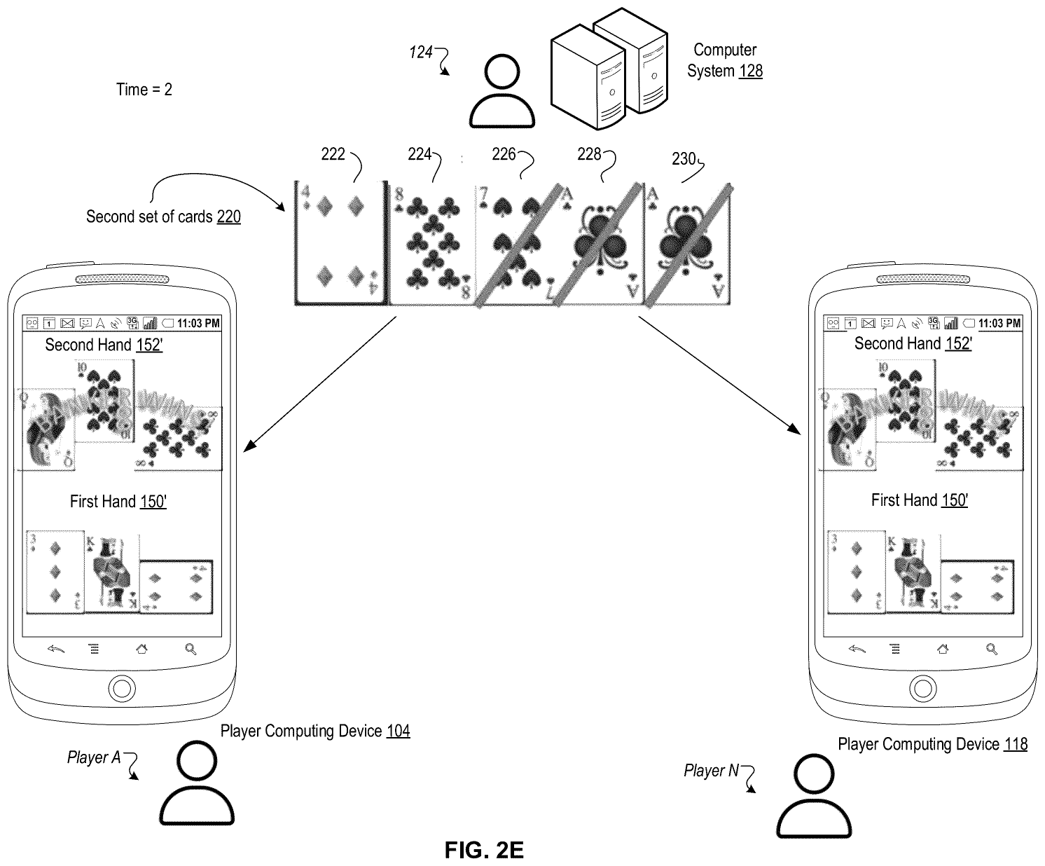

Referring to the figures, FIGS. 1A-B are conceptual diagrams of an example card-based electronic baccarat gaming system 100. A computer system 128 and player computing devices 104 and 118 can communicate (e.g., wired and/or wireless) via network 134. In some implementations, the computer system 128 can be a table computer, such as a table computer at a physical gaming table in a casino or other gaming environment. In some implementations, one or more of the player computing devices 104 and 118 may be part of or at the physical gaming table. At least one of the player computing devices 104 and 118 may be physically within the same casino or gaming environment as the physical gaming table and/or physically remote from the location of the casino, gaming environment, or physical gaming table. Moreover, any number of players can play a game of baccarat from their respective player computing devices. Refer to FIGS. 2A-E for further discussion about the components of the electronic gaming system 100.

The computer system 128 can be configured to provide card-based electronic baccarat gaming to the player computing devices 104 and 118. The computer system 128 can continuously deal sets of cards (e.g., electronic cards, physical cards dealt by a dealer and scanned by a scanner), determine initial first and second hands for a new game of baccarat using the continuously dealt sets of cards, gaming outcomes based on applying baccarat gaming rules to the first and second hands, hit cards, and/or gaming payouts based on bets placed by the players at the player computing devices 104 and 118. As described below in reference to FIGS. 2A-B, a table computer at a physical gaming table where the physical cards may be dealt by a dealer can also be configured to perform the operations performed by the computer system 128 as described in FIGS. 1A-B.

As shown in FIG. 1A, the computer system 128 can continuously deal and identify sets of cards (block A). Described further below, the cards can be physical cards that are continuously dealt by a dealer, such as a human dealer and/or a robot/machine dealer, scanned, and then translated into electronic cards having card values corresponding to the actual card values on the physical cards. Sometimes, the cards can be electronic cards and the computer system 128 can continuously deal and identify the sets of electronic cards in block A. Each set of cards can include 5 cards. Each set of cards can also include a timestamp indicating a time at which the set of cards was dealt and/or identified. The timestamp can be used to determine which set of cards to use, by the computer system 128, in response to an action or request made at the player computing devices 104 and 118. The sets of cards can be used for a variety of different games offered at the player computing devices 104 and 118, including but not limited to baccarat, five-card draw poker, other poker games, roulette, and craps.

In block B, at time t=1, at least one of the player computing devices 104 and 118 can transmit a request to the computer system 128 to play a game of baccarat. The request may include one or more bets on one or more first and second hands that will be used in the game. The bet(s) can be placed by user-selection of a graphical element 154 presented at the player computing devices 104 and 118. The graphical element 154 can be a button.

The computer system 128 can identify a first set of cards in block C. The first set of cards can be a set of cards that was dealt (block A) at the time of the request, t=1. The first set of cards can also be identified using one or more other threshold amounts of time from the time of the request, t=1, as described further below.

From the first set of cards, the computer system 128 identifies first and second hands (block D). For the game of baccarat, the computer system 128 can identify a first card in a card sequence of the first set of cards as a first card in the first hand (e.g., a player hand). The computer system 128 can identify a second card in the card sequence of the first set of cards as a first card in the second hand (e.g., a banker hand). The computer system 128 can identify a third card in the card sequence as a second card in the first hand and a fourth card in the card sequence as a second card in the second hand. A fifth card in the card sequence of the first set of cards can then be discarded and therefore not used in dealing subsequent sets of cards in block A. In other implementations, different cards in the set of cards can be selected for the four cards assigned to two hands, and/or the four cards can be selected and assigned to two hands in a different order.

The computer system 128 can determine first and second counts for the respective first and second hands (block E). According to baccarat gaming rules, the computer system 128 can summate the card values for the first and second cards in the first hand to determine a first total for the first hand. The computer system 128 also summates the card values for the first and second cards in the second hand to determine a second total for the second hand.

In block F, the computer system 128 can determine whether at least one of the first and second counts satisfy a gaming rule. For example, if the first total or the second total equals a value of 8 or 9, then the respective hand wins and therefore satisfies a baccarat gaming rule. As another example, the gaming rule can be a rule to determine whether hit cards should be applied to either the first and/or second hands. Therefore, if the first hand satisfies one or more gaming rules for receiving a hit card, the computer system 128 can identify and add a hit card, from a next dealt set of cards, to the first hand. Refer to FIG. 1B for further discussion. Based on an updated total for the first hand, which now includes the hit card, and baccarat gaming rules, the computer system 128 can determine whether a hit card should be assigned to the second hand. Also refer to FIG. 1B for further discussion.

In block G, the computer system 128 can transmit data representative of a result of the game based on the determination of whether the gaming rule is satisfied. Each of the player computing devices 104 and 118 can output the result in the respective GUI displays (block H). For example, each of the player computing devices 104 and 118 can display the first and second cards in the first hand 150 and the first and second cards in the second hand 152. As shown in FIG. 1A, each of the player computing devices 104 and 118 have the same cards for the first hand 150 and the second hand 152 because the players at the devices 104 and 118 started the game at the same time t=1. If, for example, the player computing device 104 started the game at time t=1 and the player computing device 118 started the game at time t=2, then the first hand 150 and the second hand 152 can have different cards at each of the devices 104 and 118 (e.g., the first hand 150 and the second hand 152 at the player computing device 104 can have cards that were dealt in a set at time t=1 and the first hand 150 and the second hand 152 at the player computing device 118 can have cards that were dealt in a set at time t=2).

Although not depicted in FIG. 1A, the player computing devices 104 and 118 can also output results that include whether the first hand 150 or the second hand 152 wins the game, whether the hands are tied, a payout for either player at the player computing devices 104 and 118, whether at least one hit card will be drawn and applied to at least one of the first hand 150 and the second hand 152, total counts for the first hand 150 and the second hand 152, and/or betting options.

Any of the blocks A-H described in FIG. 1A can be performed in one or more other orders. For example, card data for the first hand 150 and the second hand 152 can be transmitted to the player computing devices 104 and 118 (block G) before the computer system 128 performs one or more of blocks E or F. As another example, bets can be placed and received from the player computing devices 104 and 118 before, during, and/or after the computer system 128 performs blocks C, D, E, F, and/or G, depending on a stage of gameplay at each of the player computing devices 104 and 118 and/or baccarat gaming rules applied to the current game.

Referring to FIG. 1B, one or more additional actions may occur during the game that is shown and described in FIG. 1A. At time t=2, the computer system 128 may still be continuously dealing and identifying sets of cards (block A). After the player computing devices 104 and 118 output the result in block H shown in FIG. 1A, at least one of the player computing devices 104 and 118 can transmit data to the computer system 128 that is representative of at least one bet on the first hand 150 and/or the second hand 152 (block I). The at least one bet can be placed by selected, by the player, the graphical element 154 that is presented in the GUI display of the player computing devices 104 and 118.

Sometimes, the player computing devices 104 and 118 and/or the computer system 128 can set a countdown timer, during which players at either of the computing devices 104 and 118 must place their bets. Once the timer is up, no more bets can be placed and the computer system 128 can proceed with next actions in the game of baccarat, such as determining whether at least one hit card should be assigned to the first and/or second hand, determining a gaming outcome, and/or determining payouts for the players at the computing devices 104 and 118. As described in reference to FIG. 1A, block I can also be performed before the initial first and second hands are identified in block D.

In block J, the computer system 128 can identify a second set of cards that were dealt at time t=2. The second set of cards can be used to assign at least one hit card to the first and/or second hands. Block J can be performed at various other points during gameplay, such as before receiving the at least one bet (block I) and/or after determining whether the at least one of the first and second counts satisfy a gaming rule in block F (refer to FIG. 1A).

Using known baccarat gaming rules, the computer system 128 can identify and assign hit cards from the second set of cards to at least one of the first and second hands (block K). Block K can also be performed at various other points during gameplay, such as before receiving the at least one bet (block I) and/or after determining whether the at least one of the first and second counts satisfy a gaming rule in block F (refer to FIG. 1A). Then, the computer system 128 updates the respective first and/or second counts for the respective first and second hands based on the assigned hit cards (block L). The computer system 128 determines whether at least one of the updated first and second counts satisfy the gaming rule (block M). In other words, the computer system 128 can determine whether the first hand and/or the second hand, based on being assigned the hit card(s), now has a total value (e.g., count) that is closest to 8 or 9. If either the first hand or the second hand has the total value closest to 8 or 9, that hand wins. The computer system 129 can transmit data representative of a game result based on the determination of whether the gaming rule is satisfied to the player computing devices 104 and 118 (block N). Accordingly, the player computing devices 104 and 118 can output the result in block O.

As described in reference to FIG. 1A, the player computing devices 104 and 118 can output the updated first hand 150′ and/or the updated second hand 152′. The updated first hand 150′ and the updated second hand 152′ can include cards in the respective initial hands as well as the at least one hit card that is assigned to the first hand and/or the second hand (blocks J-K). The player computing devices 104 and 118 can also output information indicating whether the first hand or the second hand wins, whether the hands are tied, a gaming outcome, a payout to each of the player computing devices 104 and 118, or other gaming information.

Similar to the blocks A-H in FIG. 1A, any of the blocks A, I-O described in FIG. 1B can be performed in one or more other orders. Any one or more of the blocks I-O in FIG. 1B can also be performed before, during, or after any of the blocks A-H in FIG. 1A.

FIGS. 2A-B are conceptual diagrams of an example card-based electronic gaming system that can be used for the baccarat gaming system 100 of FIGS. 1A-B. As shown in FIG. 2A, the system 100 includes an example gaming table 102 that includes player computer devices 104-118 (e.g., touchscreens, electronic screens or displays) that are located at each of the positions for the table 102. The table 102 also includes a scanner 122 that is configured to automatically detect cards that are dealt out of the shoe 120 by a dealer 124. In some implementations, the scanner 122 can also be configured to automatically detect cards that are dealt out of the shoe 120 by a robot dealer, a table computer 126, or another computing system, such as the computer system 128, described above in reference to FIGS. 1A-B.

The scanner 122 can be implemented in any of a variety of ways, such as an optical scanner that is configured to detect each card that is dealt from the shoe 120 through optical recognition of one or more unique portions of the cards (e.g., image recognition techniques to identify the suit and number for each card and/or to identify a code printed on each card, such as a barcode or QR code), radio frequency-based identification (e.g., recognition of RFID tags included in each card), and/or other identification techniques. The scanner 122 can be a barcode scanner, QR code scanner, camera (e.g., overhead camera(s) over the table 102), other optical scanner, RFID reader, or other radio frequency scanner that can accurately detect physical playing cards that are dealt by the dealer 124 (e.g., a human or a robot at a physical gaming table) and to use those dealt cards to provide electronic gaming outcomes to players. Gaming systems that use any of a variety of card scanners to obtain physical card information may be referred to as “dealer assist” gaming systems. In some implementations, the cards that are dealt out of the shoe 120 are specialized playing cards with one or more features (e.g., codes, RFID tags) that are specifically designed for detection by the scanner 122. In other implementations, the cards that are dealt out of the shoe 120 are standard playing cards without specially designed features.

Card-based electronic five-card baccarat gaming is provided at the table 102 through the use of table computer system 126 that, in combination with the scanner 122, detects the cards that are dealt from the shoe 120 by the dealer 124 (which can be a human, robot, or other mechanical dealing equipment/machine), manages gaming information and interactions through the player computer devices 104-118, and determines gaming outcomes based on the cards that are dealt and the player actions (as designated through the devices 104-118). The shoe 120 can store one or more decks of physical playing cards that are ordered within the shoe 120 through physical shuffling of the cards (e.g., machine shuffling, manual shuffling, or a combination thereof). Through these collective parts (e.g., table 102, table computer system 126, scanner 122, shoe 120, dealer 124, devices 104-118), the system 100 can provide dealer assist electronic gaming to players through the use of physical cards, including games such as baccarat. The system 100 can also simultaneously provide a variety of different dealer assist electronic games, including but not limited to electronic five-card draw poker gaming.

Sometimes, the table computer system 126 is programmed to use common cards to provide baccarat gaming across the players through the devices 104-118. Sometime, only some of the devices 104-118 can be occupied by players. Further, the players can join the game at different times before or while the cards are being dealt by the dealer 124 at the table 102. For example, the table computer system 126 can detect first and second initial hands (e.g., player and banker hands in baccarat) of cards C1-C5 dealt by the dealer 124 and can transmit information identifying the cards C1-C5, or a portion of the cards C1-C5 to the player devices (e.g., one, some or all of the devices 104-118) that are currently occupied by the players for game playing. Each of the occupied player devices, which can be any of a variety of computing system with an associated display (e.g., tablet computing equipment, embedded computing equipment), can present the initial hands to the players along with selectable options to place bets on the first and/or second hands. Sometimes, the selectable options can be presented before the cards for the initial first and second hands are displayed at the occupied player devices. Once the first and second hands are displayed, the selectable options may no longer be displayed, or the options can be displayed as un-selectable options. In another example, the devices 104-118 can include physical buttons corresponding to different types of gaming actions that can be taken in a game of baccarat. Player actions can be maintained locally on the devices 104-118 and/or can be transmitted to the table computer system 126.

The dealer 124 can continuously deal sets of cards, one example of which is a set of cards D1-D5. The dealer 124 can deal cards at a particular interval, for example, every 5 seconds, 10 seconds, 15 seconds, 20 seconds, 30 seconds, etc. Since the dealer 124 is continuously dealing cards, whenever one of the players requests to play a game, they can immediately receive first and second hands in a game of baccarat that was dealt at a same time or similar time as a time of the request (e.g., a time shortly after the time of the request). The players can continue to play the game at their desired paces, without being slowed down by gameplay pacing of other players. 5 cards, such as the cards C1-C5, can be exposed, and the cards can continuously be shuffled into decks. Multiple players can then play off the same 5 cards at their desired paces. As a result, an entire process of the game may not be slowed down. Moreover, relatively fast players may not have to wait for relatively slow players to take gaming actions. Furthermore, the odds can become different since all the cards except for the 5 exposed cards are continuously being shuffled and transmitted to players based on times at which they request sets of cards (e.g., start a game, place bets). Continuous shuffling and dealing can therefore mitigate risk that multiple players may win with the same cards.

Since the dealer 124 is continuously shuffling and dealing sets of cards, players can join a game at any moment. The new player can receive cards for first and second hands in a game of baccarat that are dealt at (e.g., on or shortly before) a time at which the player joins the game. Another player currently playing a game of baccarat can receive hit cards for their respective first and second hands if the another player requests cards (e.g., the table computer 126 determines that there is no winning hand) at a same or similar time as when the new player joins the game. Otherwise, the another player can receive a set of cards for the first and second hands that are dealt at whatever time the another player requests the cards (e.g., starts a game). As an example, the dealer 124 can deal 5 cards at a first time and a first player can receive a subset of these cards for the first and second hands in their game of baccarat. A second player can join at a second time and the dealer 124 can deal a second set of cards at a third time. The second player can receive a subset of the cards that dealt at the third time for their first and second hands in baccarat. The first player can also receive hit cards that were dealt at the third time based on one or more gaming outcomes determined based on the cards in the first and second hands at the first time. In some implementations, the second player can receive a set of cards for the first and second hands that were dealt at the first time when they join the game. Since 5 cards that are initially exposed for one player can be used as hit cards for one or more other players, the disclosed technology provides for continuous game progression for multiple players who can have different gameplay paces.

The table computer system 126 and/or the player devices 104-118 can determine the outcome of the game for each player based on the initial first and second hands derived from cards C1-C5, the player's actions (e.g., bets, side bets), and one or more hit cards from the cards D1-D5. The cards C1-C5 and D1-D5 can be separately dealt sets of cards. In some implementations, only one set of currently dealt cards (e.g., D1-D5) can be presented on the table 102 and a previously dealt set of cards (e.g., C1-C5) can be discarded or otherwise moved aside from the table 102. In some implementations, the table computer system 126 (in combination with the central computer system 128 described above) can determine and manage gaming at each of the positions, and can simply use the devices 104-118 to present information to the players and to obtain player inputs (e.g., discard selections, bet amounts). In other implementations, each of the devices 104-118 can manage an individual player's gaming and can communicate with the table computer system 126 to receive card information. Other implementations are also possible.

The system 100 can additionally incorporate and permit remote players to play baccarat on the table 102, such as through other computing equipment 136 and 138 (e.g., smartphones, tablet computers, wearable computing equipment (e.g., smart watches), desktop computers, laptop computers, media computers, virtual reality systems, augmented reality systems). For example, the system 100 can use the central computer system 128 to connect remote players with the table computer system 126 so that remote players can additionally participate in baccarat gaming on the table 102. Such remote players may be located in the same facility as the table 102 (e.g., casino, card club, horse track) and/or remote from such a facility (e.g., located remotely, at home). Via the equipment 136 and 138, the remote players can connect to the computer system 128 and the table computer system 126 to participate in baccarat gaming at the table 102 and/or other tables 130-132 over one or more networks 134, such as the internet, local area networks (LAN), wide area networks (WAN), virtual private networks (VPN), mobile data networks (e.g., 4G LTE networks), wireless networks (e.g., Wi-Fi networks, BLUETOOTH networks), and/or combinations thereof. The remote electronic equipment 136 and 138 can download and run code from the computer system 128 to provide electronic baccarat gaming on the equipment 136 and 138 (e.g., provide user interfaces to establish/login to user accounts, to designate bet amounts, to present initial first and second hands, to receive game actions, to present final first and second hands, to determine gaming outcomes based on the final first and second hands, and to allocate winnings to the player account). Such code can be, for example, a mobile application (“mobile app”) that is downloaded and installed on the computing equipment 136 and 138, a browser-based application that is downloaded and run within a web browser application on the computing equipment 136 and 138, a standalone application that is downloaded and installed on the computing equipment 136 and 138, and/or other types of code and/or applications.

The computer system 128 can additionally allow players, such as local players using devices 104-118 and/or remote players using equipment 136-138, to bounce between gaming at tables 102 and 130-132, to play multiple hands simultaneously/concurrently across the tables 102 and/or 130-132, and to even combine common cards from multiple different tables 102 and 130-132 for either first and/or second hands in a baccarat game. For example, a player can press a button requesting that the computer system 128 place him/her in the table that is going to be dealing next, so as to allow the player to minimize wait time. The computer system 128 can automatically transfer such a player to a table that is the first to scan cards for initial first and second hands in a game of baccarat, and can present the initial first and second hands from that table to the player, even though the player may be located at another table or remote from the table. In a further example, a player may be permitted to concurrently play multiple hands across the tables 102 and/or 130-132. Additionally, the computer system 128 may perform load balancing of players so as to more evenly distribute players across the tables 102 and 130-132.

The computer system 128 can additionally distribute video, audio, and/or chat feeds for the tables 102 and 130-132 to remote players using the computing equipment 136-138.

Still referring to FIG. 2A, the dealer 124 can continuously deal sets of cards in block A. For example, as soon as at least one player joins a game, the dealer 124 can start to deal sets of cards and continue to deal sets of cards until all the players are done, the game has ended, or some input is received that indicates an end of gameplay. The dealer 124 can deal cards at a dealer-desired pace (e.g., as quickly as the dealer 124 can shuffle and deal sets of cards and/or at timed intervals, as described above). The dealt cards can be scanned by the scanner 122. Once scanned, the dealt cards are ready to be transmitted to any of the devices 104-118 and/or the other player computing equipment 136-138 when requested by the players. In some implementations, the dealer 124 may wait to deal sets of cards until a first player has joined a game. In some implementations, the dealer 124 may wait to deal sets of cards until one player provides first input at their devices 104-118 and/or computing equipment 136-138. The first input can, for example, be a pause action, a resume action, a request for cards to build initial first and second hands, and/or a request for hit cards (or a request for a determination of whether hit cards are needed based on the initial first and/or second hands). In yet some implementations, the dealer 124 can continuously deal sets of cards regardless of whether and/or when a player joins a game at the dealer 124's table 102.

Players can place bets on the first and second hands during gameplay in block B. The players can place bets before they receive or see the initial first and second hands. The players can additionally or alternatively place bets after seeing the initial first and second hands and before a hit card is added to either the first hand and/or the second hand. The players can be instructed to place their bets within a threshold amount of time between gaming actions. For example, the players may be allowed to place bets at their devices 104-118 for a threshold amount of time (e.g., 30 seconds) between viewing the initial first and second hands and viewing updated first and second hands with at least one hit card. If, for example, a player does not place a bet within the threshold amount of time, the player may place a bet during a subsequent threshold amount of time and/or may not be permitted to place a bet during the current gameplay. Players can provide input at their devices 104-118 and/or computing equipment 136-138 that indicates that they are placing a bet for the first hand and/or the second hand. For example, a player can make a bet on the first hand as input, which can be transmitted from the player's computing equipment to the table computer 126 or the computer system 128. Based on this input, the table computer 126 or the computer system 128 can determine a gaming outcome and/or a payout for the particular player.

In block C, the table computer 126 can transmit one or more cards, such as at least one hit card and/or cards in the initial first and second hands, and/or game results/outcomes to one or more of the devices 104-118. As mentioned above, cards that are dealt are scanned by the scanner 122. The table computer 126 can transmit subsets of the sets of scanned cards to one or more of the devices 104-118 and/or player computing equipment 136-138. A first subset of the scanned cards can be a first hand and a second subset of the scanned cards can be a second hand. A set of scanned cards may also be used by the table computer 126 to determine at least one hit card to add to the first hand and/or the second hand. The at least one hit card can also be transmitted to the one or more of the devices 104-118 and/or player computing equipment 136-138 based on a determination of whether the first hand and/or the second hand satisfies one or more baccarat gaming rules. Refer to FIGS. 1A-B for further discussion. Moreover, as described herein, the table computer 126 can transmit game results/outcomes to the devices 104-118 and/or the player computing equipment 136-138 based on whether the first hand and/or the second hand satisfies the one or more baccarat gaming rules. Any such information transmitted to the devices 104-118 and/or the player computing equipment 136-138 can be outputted in respective GUI displays for presentation to the respective players.

The table computer 126 can maintain each set of dealt cards with a respective timestamp indicating a time at which the set of cards were dealt and/or scanned by the scanner 122. When a request for cards (e.g., when a player starts a new game of baccarat) or other input is received from one or more players (e.g., when a player places a bet on existing first and second hands during a current game of baccarat), the table computer 126 can transmit a set of dealt cards (e.g., initial first and second hands for a new game of baccarat, at least one hit card for the first hand and/or the second hand during a current game of baccarat) having a timestamp that is most similar to (e.g., shortly after or shortly before) a timestamp of the request from the one or more players. In some implementations, the table computer 126 can transmit each set of dealt cards to each of the players' computing equipment (e.g., the devices 104-118 and/or the computing equipment 136-138) as they are dealt. The players' computing equipment can then determine which set of cards to present to the players based on a comparison of timestamps of each set of dealt cards with requests for cards from the players.

In some implementations, the table computer 126 can associate times at which physical cards are dealt with times at which such cards are scanned by the scanner 122 and registered by the table computer 126. This can be advantageous to recognize lag and/or relative timing to more accurately determine which sets of cards should be transmitted to which player computing equipment. As a result, players who are physically at the table 102 may not have advantages over online or remote players who cannot see the cards being physically dealt at the table 102. Moreover, online or remote players may not be able to take advantage of the time lag described above to know in advance what next cards will be registered and then transmitted to them.

FIG. 2B is another conceptual diagram of the example card-based electronic gaming system 100. Here, the table computer 126 may use prerecorded sequences of cards that are dealt into grid 127, which may be a virtual grid of cards. The shoe 120 can store one or more decks of physical playing cards that are randomly ordered within the shoe 120 through physical shuffling of the cards (e.g., machine shuffling, manual shuffling, or a combination thereof).

The size and shape (e.g., the number of columns and rows) for grid 127 may vary based on the type of game(s) being offered by system 100 and/or the number of players that can be supported by system 100. The dealer 124 may place each card as dealt from the shoe 120 into the grid 127 based on a particular pattern. For example, a first card may be placed in position A1, a second card may be placed in position A2, and so forth until the grid is filled. As an alternative example, the first card may be placed in position N5, the second card may be placed in position N4, and so forth until the grid is filled. Any number of patterns may be employed to fill the grid 127. The pattern can be switched by the dealer 124 after each grid is used to determine gaming outcomes or after a particular number of grids have dealt and used. The patterns used for card placement into the grid 127 may be rotated through based on a particular ordering of the patterns. Grid 127 may also be built virtually by the table computer 126 as the cards are dealt by the dealer 124 and read by the scanner 122, or based on a prerecorded dealt sequence of cards.

Through these collective parts (e.g. table 102, table computer system 126, scanner 122, shoe 120, dealer 124, devices 104-118), the system 100 can provide dealer assist electronic gaming to players through the use of physical cards as dealt into the grid 127, where the gaming outcomes are determined by the random ordering of physical playing cards within the shoe 120 instead of through a random or pseudo-random number generator.

The table computer 126 determines initial and next gaming outcomes for each player computer device 104-118 and remote computer devices/equipment 136-138 based on the cards in grid 127 for both card based and non-card based games. Examples of card based table games include, but are not limited to, Baccarat, Blackjack, Casino war, Faro, Poker and its variants, Red Dog, Teen Patti, and Trente et Quarante. Examples of non-card based table games include, but are not limited to, Chuck-a-luck, Craps, Pai Gow, Sic bo, Big Six wheel, Roulette, Fan-Tan, and Two-up. The table computer 126 may employ multiple grids to manage multiple games at the same time or to use one grid from which to select initial hands and another grid from which to select additional or replacement cards.

Similarly to the example in FIG. 2A, the table computer 126 is programmed to use common cards that are continuously dealt to provide electronic gaming to the players through the devices 104-118. For example, the table computer 126 can detect an initial hand of cards (or initial first and second hands of cards for a game of baccarat) based on the cards dealt by the dealer 124 and their placement in grid 127. The table computer 126 can transmit information identifying the initial cards to the player devices being currently occupied by players (e.g., one, some, or all of the devices 104-118). Each of the occupied player devices, which can be any of a variety of computing devices with an associated display (e.g., tablet computing device, embedded computing device) as described herein, can present the initial hands (or initial first and second hands) to the players along with selectable options to place bets, wages, or other gaming actions based on the presented initial hands. For example, the devices 104-118 can include touchscreens that present selectable buttons to place a bet on the first initial hand and/or the second initial hand. In another example, the devices 104-118 can include physical buttons corresponding to each of the initial cards through which the player can designate what actions to take. Additionally, multiple games/hands may be displayed by the devices 104-118 to a respective player. Player actions can be maintained locally on the devices 104-118 and/or can be transmitted to the table computer 126.

Once a player action is received, additional cards, such as hit cards, can be selected from cards in the grid 127 by the table computer 126 (e.g., via the scanner 122), wherein each of the cards in the grid 127 have been continuously dealt by the dealer 124. The selected cards can then be applied to the player whose action is received. As described in reference to FIG. 2A, this allows for each of the players to play the game at their desired pace without being slowed down or forced to wait for other players to make decisions in gameplay.

The dealer 124 may also deal a second grid 127 of cards from which the additional cards can be selected by the table computer 126. The second grid 127 may be dealt according to the same pattern as the first grid or a different pattern may be used. For example, A1 can be applied as a first hit card for the first initial hand, A2 can be applied as a first hit card for the second initial hand, and so on. Any of the cards in the grid 127 can also be selected as at least one hit card based on one or more baccarat gaming rules. The table computer 126 may also use any variety of rules to identify which cards in the card sequence A1-A5 should be assigned as a hit card for the first hand and/or a hit card for the second hand.

The table computer 126 and/or the player devices 104-118 can determine the outcome of the game for each player based on the initial first and second hands provided from grid 127, the player's actions (e.g., bets placed on the first and second hands), and the hit cards taken from grid 127 or from a second dealt grid. In some implementations, the table computer 126 (in combination with a central computer system 128) can determine and manage gaming at each of the positions, and can use the devices 104-118 to present information to the players and to obtain player inputs (e.g., bet amounts, side bets). In the depicted example of FIG. 2B, the table computer 126 manages Games A-N for each of the devices 104-118 as well as remote devices 136-138. In other implementations, each of the devices 104-118 can manage an individual player's gaming and can communicate with the table computer 126 to receive card information. Other implementations are also possible.

As described above in reference to FIG. 2A, each of the players at the devices 104-118 can receive sets of cards for each of the Games A-N based on times at which the players provide input indicating a need for a set of cards. The dealer 124 can continuously deal sets of cards that are scanned by the scanner 122. The table computer 126 can then receive requests for cards (e.g., requests to start new games) from any of the devices 104-118 and/or the computing equipment 136-138. The table computer 126 can transmit cards that were dealt at times that are the same or similar to the requests for any of the Games A-N that are played at the devices 104-118 and/or the computing equipment 136-138. Thus, continuous gameplay progression can exist for each of the players in each of their Games A-N. The players can continue to play a variety of different games at their desired paces without having to slow down or speed up gameplay to compensate for gameplay paces of other players at the table 102 and/or remote from the table 102.

FIG. 2C is a conceptual diagram of timing for example gameplay with the card-based electronic baccarat gaming system of FIGS. 1A-B and 2A-B. Here, 2 players A and N are playing a game at player computer devices 104 and 106, respectively. The dealer 124 continuously generates sets of cards at predetermined time intervals in block A. As described with regards to FIGS. 2A-B, the dealer 124 can continuously deal sets of cards that are scanned by the scanner 122 and transmitted to the table computer 126. The players A and N may play one or more games at different paces. A first group of players, for example, who play at a same pace can receive the same cards from the dealer 124 as the cards are continuously being dealt. Those same cards can be used to play same or different games. A second group of players can play games at another pace and therefore receive different cards than the first group of players. Although each of the groups may receive different cards from the same dealer 124, one or more of the second group of players may still play the same games as one or more of the players in the first group, albeit at different paces.

As an illustrative example, in a game of baccarat, the first group of players can receive hit cards from a set of cards that were dealt at time t=2 for at least one of first and second hands. Also at time t=2, the second group of players can receive initial first and second hands from the same set of cards that the hit cards originated from. Sometimes, first and second players can start a game of baccarat together but then continue the game at different paces. For example, the second player can be slower in gameplay than the first player (e.g., the second player can step away from their computing device for some period of time, they may be switching between playing different games). The second player can then receive at least one hit card for at least one of the first and second hands from a different set of dealt cards than the first player, who started the game at the same time but plays the game quicker. The first player may receive at least one hit card from a set of cards that were dealt before the set of cards that were used to assign the at least one hit card for the second player's gameplay.

Furthermore, hit cards can be assigned from a variety of continuously dealt sets of cards. For example, at least one hit card can be assigned from a set of cards that was dealt immediately after a set of cards that were used to assign the initial first and second hands for a game of baccarat. As another example, the at least one hit card can be assigned from the same set of cards that was used to assign the initial first and second hands. Sometimes, different sets of cards can be used to assign the initial first and second hands. Therefore, the at least one hit card can be assigned from at least one of the different sets of cards that were used to assign either of the initial hands. As yet another example, the at least one hit card can be assigned from a set of cards that was dealt a threshold amount of time after the set of cards that were used to assign the initial first and second hands. A variety of other options are also possible, as described throughout this disclosure.

With regards to player A in FIG. 2C, player A can start the game, such as a game of baccarat, at time=0 in block B. The player A can start the game before or during a time at which the dealer 124 is dealing the sets of cards in block B. Starting the game can include the player A performing some action or providing some user input at the device 104 that indicates the player A is ready to play the game. For example, the player A can select an option at the device 104 to begin a new game, to resume a game, to select a game to play, or to take some action (e.g., request initial first and second hands) in a game.

Player A can request a set of cards at time=1 in block C. The player A can, for example, select an option to start a new game of baccarat and/or receive a set of cards or otherwise build the initial first and second hands of cards (e.g., the player and the banker hands) for the game. This user input can be transmitted to the table computer 126 in block C, thereby indicating the player A's request for the initial first and second hands of cards. The request can include a timestamp indicating a time at which the player A requests the cards. Sometimes, the timestamp can indicate the time at which the player A begins the game (e.g., t=0) instead of the time at which the request is transmitted to the table computer 126 (e.g., t=1).

Sometimes, time t=1 can be the same time as time=0. For example, when the player A selects an option to begin a new game at the device 104, the device 104 can immediately/automatically transmit a request to the table computer 126 for a set of cards to build the initial first and second hands for the baccarat game. Sometimes, time t=1 can be the same, earlier, or later than a time at which the dealer 124 begins dealing cards or otherwise is currently dealing sets of cards in block A. Thus, the dealer 124 can already be dealing sets of cards at time t=1. In other implementations, the dealer 124 may not begin to deal sets of cards until time t=1, when the request for the set of cards is first received from the device 104 of the player A.

The device 104 can also identify what stage the player A is currently at in the game in block D. The device 104 can make this identification before, during, or after requesting the set of cards in block C. Moreover, sometimes, the device 104 can make this identification instead of the table computer 126 in order to more efficiently utilize computing resources and to avoid clogging resources of the table computer 126. An indication of the stage of gameplay can also be transmitted, by the device 104, to the table computer 126. The table computer 126 can use the stage of gameplay to determine what set of cards and/or how many cards to provide back to the device 104.

Accordingly, in block D, the device 104 can determine whether the player A is at an initial stage in which the player A receives full initial first and second hands (e.g., 2 cards per hand). The device 104 can also determine whether the player A is at betting stage in the game in which the player A can place one or more bets on the current first and second hands, before gaming outcomes are determined and/or hit cards are assigned by the table computer 126. The device 104 can also determine whether the player A is at a final stage of the game, in which gaming outcomes, payouts, and/or options to start a new game are to be determined by the table computer 126.

In block E, the table computer 126 can identify a set of cards that were generated (e.g., dealt by the dealer 124 and/or scanned by the scanner 122) at a time of the request (e.g., t=1). Sometimes, the table computer 126 can identify a set of cards that were generated within some predetermined time range from the time of the request, t=1. If, for example, a set of cards was generated at the same time as t=1, then the table computer 126 can identify that set of cards in block E. As another example, if a first set of cards was generated at a time that is several seconds before time t=1 and a second set of cards was generated at a time that is several seconds after time t=1, then the table computer 126 can identify the first set of cards. As yet another example, the table computer 126 can identify a set of cards that were dealt and generated at the time of the request in block C, such as time t=1.

In block F, the table computer 126 can select a subset of the identified cards at time t=2. The subset of the identified cards can be used to assign cards to the initial first and second hands. Sometimes, based on an action taken in the game (block H), a stage of gameplay (block D), and/or a gaming rule, the table computer 126 can select a subset of the identified cards at time t=2 that can be used as at least one hit card for the first and/or second hands.

As an illustrative example, cards in the set of cards generated at t=1 can be assigned to the initial first and second hands. The table computer 126 can then apply one or more baccarat gaming rules to the initial first and second hands to determine whether any of the first and second hands is a winning hand. If, for example, at least one of the first and second hands is not winning (e.g., a hand has a total card value that exceeds a threshold numeric value, such as 9 or 10), the table computer 126 may determine that the at least one hand should receive a hit card. Therefore, the table computer 126 can select a subset of the identified cards at t=2, or a set of cards that have been dealt at t=2, that can be used to identify and assign the hit card to the at least one hand. The table computer 126 may also apply one or more other baccarat gaming rules to determine whether, after assigning the hit card to the at least one hand, either of the first and second hands is winning and/or the other hand should be assigned a hit card. If the other hand should also be assigned a hit card, the table computer 126 can identify and assign another card from the subset of the identified cards at t=2 as the hit card. Alternatively, the table computer 126 can identify and assign a card from another subset of identified cards at another subsequent time, such as t=3 or t=4.

The table computer 126 can transmit the set of cards at t=1 and/or the subset of cards at t=2 to the device 104 in block G. Which cards are transmitted to the device 104 can depend on the player A's stage of gameplay. For example, if the player A has just started the game of baccarat, then the table computer 126 may only transmit the set of cards at t=1 that are used for the initial first and second hands. If, as another example, the player A has placed at least one bet on the initial first and second hands and the table computer 126 determines that at least one hit card should be assigned to at least one of the first and second hands, then the table computer 126 can also transmit the subset of cards at t=2 in block G, which is used as the at least one hit card.

Sometimes, whenever sets of cards are generated in block A, the table computer 126 can transmit those sets of cards to the device 104. The device 104, instead of the table computer 126, can then identify which set of cards was generated at or near a time of the request for the set of cards. This can be advantageous to reduce an amount of processing at the table computer 126. By offloading such processing to the device 104 and other player computer devices, the table computer 126 can more efficiently use its computational resources to make other determinations (e.g., determining gaming outcomes).

Still referring to FIG. 2C, once the device 104 receives the set of cards that were transmitted in block G, the device 104 can display the cards as the initial first and second hands to the player A and the player A can take some action in the game based on the displayed cards (block H). For example, the player A can place at least one bet on an outcome of the first and second hands.

Sometimes, in block H, the device 104 can take an action in the game. In other words, the device 104 can locally store one or more baccarat gaming rules. Using those rules, the device 104 can determine whether at least one hit card is needed for at least one of the first and second hands. If the device 104 determines that at least one hit card is needed, the device 104 can request a set of cards at time t=3 (block I). In other words, the device 104 can request the at least one hit card for the at least one of the first and second hands. As described above, the table computer 126 can accordingly identify a set of cards that were dealt at t=3 (or within some threshold amount of time of t=3) and select at least one of the cards from the set of cards at t=3 to assign as the at least one hit card. Data representative of the at least one hit card can then be transmitted by the table computer 126 to the device 104 and displayed to the player A along with the first and second hands. Alternatively or in addition, the table computer 126 can perform the action described in block H of determining whether at least one hit card should be assigned to at least one of the first and second hands.

In yet some implementations, at time t=2, the current baccarat game played at the device 104 may end (e.g., one of the first and second hands wins for having a total card value closest to or equal to 8 or 9). As a result, in block H, the player A can perform the action of starting a new game and requesting cards for new initial first and second hands for the new game. The device 104 can then request a set of cards for the initial first and second hands at time t=2 and/or time t=3 (block I). The blocks described above can then be performed for the new game and repeated so long as the player A is still playing the game of baccarat or otherwise playing games at the device 104.

Time t=2 can be any time later than t=1, which can depend on how quickly the player A paces their gameplay and/or makes decisions. Time t=3 can also be any time later than t=1 and/or t=2. For example, t=1, the first request for cards, can be merely seconds after the player A starts the game at t=0. However, t=2, assignment of at least one hit card, can be several minutes after the player A receives the set of cards generated at t=1 because the player A can take a longer time to make a decision and take an action in the game in block H (such as placing a bet after receiving the initial first and second hands). Regardless of how much time passes between requests and actions taken in the game, the dealer 124 is continuously dealing sets of cards in block A such that players at any stage of gameplay and/or pace of gameplay can continue to play their games at their desired paces and receive sets of cards that are generated around the same time as when the players request the sets of cards.

Still referring to FIG. 2C, the blocks described in reference to the game of player A can also be performed in reference to the game of player N. Here, player N starts the game at t=2 (block O). In this example, player N starts the game at the same time as at least one hit card is assigned to at least one of the first and second hands in the player A's game of baccarat (block F). Sometimes, the cards used for the initial first and second hands in the player N's game can be derived from the same set of cards used at t=2 for assigning the at least one hit card in the player A's game. Sometimes, the cards used for the initial first and second hands in the player N's game can be derived from a different set of cards than the cards at t=2. For example, the initial first and second hands in the player N's game can be derived from a set of cards dealt at a time of request for the set of cards, such as t=3 (block P). The player N can also start the game at any other time, including times that occur before, during, and/or after any of the blocks described above in association with player A.

The device 106 of the player N can request a set of cards at t=3 in block P. t=3 can be any time after t=2 and/or any other times described above. t=3 can also be a same, earlier, and/or later time as any of the other times described above in reference to FIG. 2C. Sometimes, the request for a set of cards can be made at t=2, when the player N begins the game.

The table computer 126 can identify a set of cards that were generated at the time of the request (block E). As described above, the table computer 126 can identify cards that were dealt at t=3, t=2, and/or any time within some predetermined range from t=3 or t=2. Sometimes, when the player N is starting the game, the table computer 126 can determine that the same cards that were transmitted to the device 104 of the player A to build player A's initial hand should also be sent to the device 106 of the player N. In such a scenario, the player N can receive the set of cards that were dealt at t=1 or t=0. The identified set of cards can then be transmitted from the table computer 126 to the device 106 (block U).

Sometimes, as shown in FIG. 2C, the table computer 126 can perform additional blocks during the game being played at the device 106 of the player N. For example, the table computer 126 can select a subset of identified cards at t=4 based on an action taken in the game (block S). As described above, the action can be taken by the player N at the device 106 (block Q), such as placing one or more bets on first and second hands of the player N's game. The action can be taken by the device 106, such as determining whether at least one hit card should be assigned to at least one of the first and second hands of the player N's game. The subset of identified cards selected at t=4 in block S can be used to assign the at least one hit card to the at least one of the first and second hands. The table computer 126 can then transmit the subset of the identified cards (e.g., the at least one hit card) to the device 106 at the same time or a different time as transmitting the set of cards at t=3 (e.g., the initial first and second hands) to the device 106.

The table computer 126 can also determine one or more game outcomes in block T. The table computer 126 can apply one or more baccarat gaming rules to the first and second hands of the player N's game to determine whether either of the hands wins or whether there is a tic. The table computer 126 can also determine payouts and other gaming outcomes in block T. Block T can also be performed to determine gaming outcomes of the player A's game. In some implementations, the baccarat gaming rules can be locally stored at the device 106 and used by the device 106 to determine the gaming outcomes. As a result, compute resources of the table computer 126 can be more efficiently allocated for other determinations and/or processes described herein. The determined game outcome(s) can also be transmitted to the device 106 in block U. Sometimes, the game outcome(s) can be determined and then transmitted for each stage of gameplay. Sometimes, the game outcome(s) can be determined and transmitted at the end of the game, such as after hit cards have been assigned to the first and/or second hands and/or all bets have been placed.

As described above in reference to the player A, the blocks described herein can repeat for the player N for so long as the player N plays the game (or starts another game of baccarat). Although the players A and N can be at different stages of gameplay, sometimes they can receive a same set of cards based on whether their devices 104 and 106 request sets of cards at same or similar times. There can also be scenarios in which the players A and N do not receive the same sets of cards at any times because the times at which their respective devices 104 and 106 request sets of cards are not within predetermined thresholds from each other and/or times at which the sets of cards are dealt (block A).

FIGS. 2D-E are conceptual diagrams of the example card-based electronic baccarat gaming system of FIGS. 1A-B and 2A-B. Referring to FIG. 2D, as described above, the dealer 124 and/or the computer system 128 can continuously deal sets of cards. At time t=1, a first set of cards 200 can be dealt. The first set of cards 200 can include cards 202, 204, 206, 208, and 210. Player A at the player computing device 104 and player N at the player computing device 118 can both begin a game of baccarat at, near, or around the same time t=1. Therefore, cards from the first set of cards 200 can be used to build first and second hands for the game of baccarat that is presented at both the player computing devices 104 and 118.

The computer system 128 can assign the card 202 in a card sequence of the first set of cards 200 as a first card in a first hand 150, the card 204 in the card sequence of the first set 200 as a first card in a second hand 152, the card 206 in the card sequence of the first set 200 as a second card in the first hand 150, and the card 208 in the card sequence of the first set 200 as a second card in the second hand 152. The card 210, which is the last drawn card in the card sequence of the first set of cards 200 can be discarded. As a result, the card 210 may not be drawn in subsequent sets of cards that are continuously dealt by the dealer 124 or the computer system 128. Alternatively, the discarded card 210 can be included in the stack of cards from which subsequent sets of cards are continuously dealt.

As shown in FIG. 2D, the cards 202 and 206 in the first hand 150 and the cards 204 and 208 in the second hand 152 are presented in GUI displays at the player computing devices 104 and 118. The player computing devices 104 and 118 also display graphical elements 154, which can be selected by the respective players A and N to place one or more bets on the first hand 150 and/or the second hand 152. As described herein, the players A and N can place their bets before the initial first hand 150 and the initial second hand 152 are determined and/or presented at the player computing devices 104 and 118. In addition or alternatively, the players A and N can place their bets after the initial first hand 150 and the initial second hand 152 are displayed at the player computing devices 104 and 118 and before gaming outcomes are determined and/or at least one hit card is assigned to at least one of the first hand 150 and the second hand 152.

Referring to FIG. 2E, the computer system 128 can determine first and second counts for the respective first hand 150 and the second hand 152. The computer system 128 can utilize known baccarat gaming rules as described above to determine the first and second counts (e.g., summating card values). The first hand 150, or the player hand in baccarat, has a total value (e.g., first count) of 3, using a 3 Diamond and a King Club. The second hand 152, or the banker hand in baccarat, has a total value (e.g., second count) of 0, using a Queen Diamond and a 10 Spade. The computer system 128 can determine whether the first and/or second counts satisfy baccarat gaming rules, such as whether either of the counts are closest to values of 8 or 9.

Since neither the first hand 150 nor the second hand 152 is satisfies the abovementioned gaming rule, the computer system 128 can identify a second set of cards 220 at time t=2, or any other time after time t=1 in FIG. 2D. The second set of cards 220 includes cards 222, 224, 226, 228, and 230. The computer system 128 can use the second set of cards 220 to identify and assign at least one hit card to the first hand 150 and/or the second hand 152. Since both hands do not satisfy the gaming rule, the computer system 128 can assign a hit card to the first hand 150 and a hit card to the second hand 152. As described herein, sometimes the computer system 128 can assign a hit card to one hand, such as the first hand 150, and then assign a hit card to the other hand, such as the second hand 152, based on one or more known baccarat gaming rules that depend on what card is drawn as the hit card for the first hand 150.

In the example of FIG. 2E, the computer system 128 assigns the first card 222 in a card sequence of the second set of cards 220 as the hit card for the first hand 150. The first hand 150 now becomes a first hand 150′, which includes the cards 202 and 206 of the initial first hand 150 in FIG. 2D and the hit card 222. The computer system 128 also assigns the second card 224 in the card sequence of the second set of cards 220 as the hit card for the second hand 152. The second hand 152 now becomes a second hand 152′, which includes the cards 204 and 208 of the initial second hand 152 in FIG. 2D and the hit card 224. Although sequential cards are selected as the at least one hit card from the second set of cards 220, the computer system 128 can employ other rules or algorithms to select which cards in the second set of cards 220 are selected as the at least one hit card. Moreover, the cards 226, 228, and 230 in the card sequence of the second set of cards 220 are discarded and therefore may not be drawn in subsequent sets of cards by the dealer 124 or the computer system 128.

Each of the player computing devices 104 and 118 can display the first hand 150′ and the second hand 152′ to the respective players A and N. In some implementations, if the player N plays the game slower than player A, the first and second hands of player N's game may include different hit cards, such as cards that are dealt and identified in a third set of cards. The third set of cards can be dealt at, near, or within a threshold amount of time as a time at which the player N performs some action. For example, the third set of cards can be dealt at time t=3 and the player N can finish placing their bets at time t=3. Once the player N's bets are placed and transmitted to the computer system 128, the computer system 128 can assign the hit cards for the first and second hands shown at the player N's computing device 118 from the third set of cards that were dealt at time t=3.

As shown in FIG. 2E, the player computing devices 104 and 118 can also display a gaming outcome. Here, the second hand 152′ has won the game, according to known baccarat gaming rules. As a result, each of the player computing devices 104 and 118 display an overlaid graphical element with text indicating that the banker wins. The overlaid graphical element can also indicate a total (e.g., the second count) for the winning hand. Here, the second hand 152′ wins because it has a total, or second count, of 8, using an 8 Club, which is closest to a value of 8 or 9. The first hand 150′, on the other hand, has a total, or first count, of 7 using a 4 Diamond as the hit card.

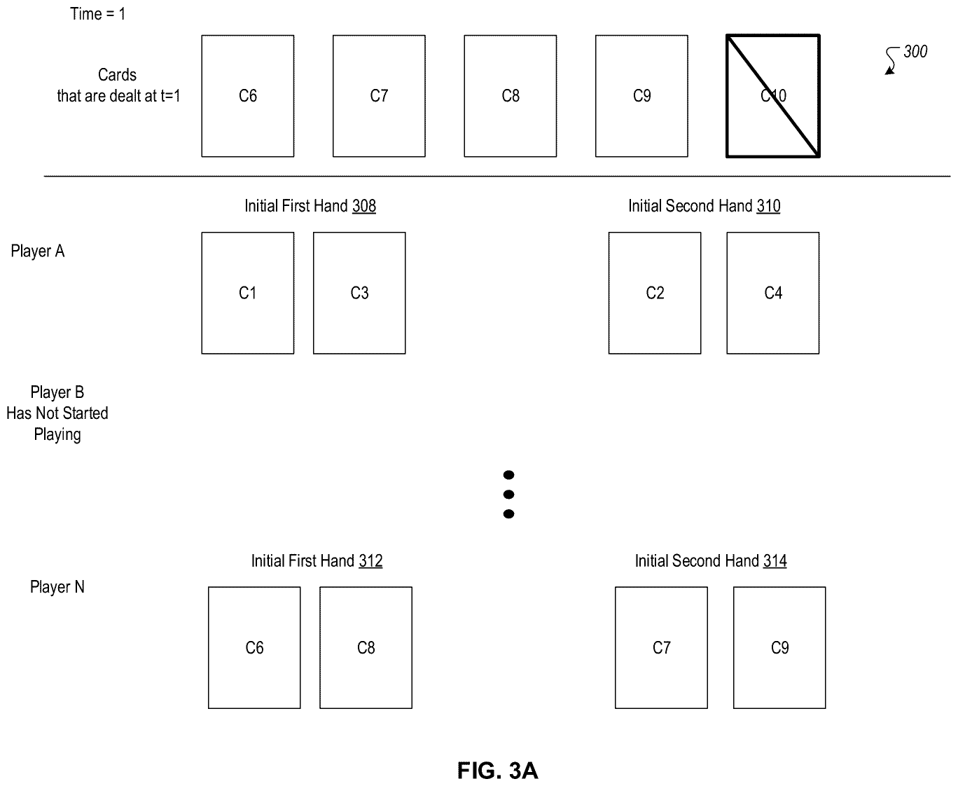

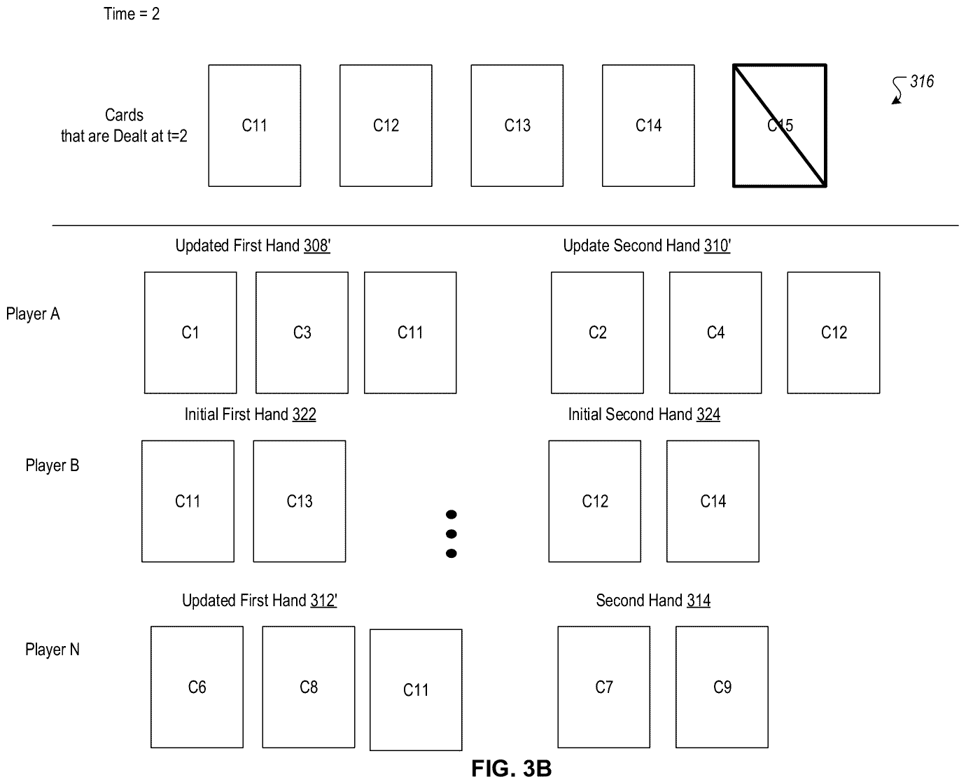

FIGS. 3A-B depict example game play using cards that are continuously dealt with an example card-based electronic baccarat gaming system. As shown in FIG. 3A, physical cards hand 300 are dealt by a dealer at time t=1, as presented above the line. Cards that are presented to example players A-N on computing equipment, such as devices 104-118 and 136-138, are presented below the line. FIG. 3A presents the initial hands that are dealt to the players A-N.

For example, at time=1, the dealer deals the hand 300, which includes cards C6, C7, C8, C9, and C10. At time=1, player A already has an initial first hand 308 and an initial second hand 310, which include cards that were dealt before time t=1, such as at time t=0. Thus, the player A's initial first hand 308 includes cards C1 and C3 and the player A's initial second hand 310 includes cards C2 and C4. Player A has not yet taken action in the game, such as placing a bet. Moreover, a determination of whether either of the hands 308 and 310 require a hit card has not yet been made by a computer system, such as the table computer 126 or the computing system 128. Therefore, none of the dealt cards 300 are used to update either of the hands 308 and 310 of the player A.

Player B has not yet started playing the game, and therefore does not have initial first and second hands.

Player N, however, has just started the game at time t=1. Thus, the dealt hand 300 is used to build an initial first hand 312 and an initial second hand 314 for the player N. Player N's initial first hand 312 therefore includes cards C6 and C8 and the player N's initial second hand 314 includes cards C7 and C9 from the dealt hand 300.

The card C10 is discarded from the dealt hand 300 since it was not used to build the hands of the player N.

Referring now to FIG. 3B, a new set of cards has been dealt at time t=2 as hand 316. The hand 316 includes cards C11, C12, C13, C14, and C15. The cards in the hand 316 can be used to perform actions with regards to any of the initial first and second hands of any of the players A-N at time t=2.

For example, at time t=2, the computer system can determine that both the first and second hands 308 and 310 of the player A require hit cards. The computer system can assign the card C11 as a hit card for the first hand such that the player A has an updated first hand 308′ including the cards C1, C3, and C11. The computer system can assign the card C12 as a hit card for the second hand such that the player A has an updated second hand 310′.

At time t=2, player B has started a game of baccarat. As a result, the computer system can assign the first card C11 and the third card C13 in a card sequence of the hand 316 to an initial first hand 322 and assign the second card C12 and the fourth card C14 in the card sequence of the hand 316 to an initial second hand 324 for the player B.

Also at time t=2, the computer system can determine, based on applying known baccarat rules, that Player N's first hand 312 requires a hit card. The computer system can therefore assign the first card C11 in the card sequence of the hand 316 to the first hand 312. Now the player N can have an updated first hand 312′ including 3 cards: C6, C8, and C11. According to the baccarat gaming rules, the computer system may determine that the player N's second hand 314 does not require a hit card. Therefore, the second hand 314 can remain having the cards that were initially dealt at time t=1, which include cards C7 and C9.

Outcomes for games played by the players A, B, and N can be determined by the computer system and based on the cards in their respective hands 308′-310′, 322-324, and 312′-314. The computer system can utilize one or more known baccarat gaming rules to determine the gaming outcomes and payouts to the players A, B, and N. A variety of factors can additionally impact gaming outcome determinations for each of the players A, B, and N as well as payout odds, such as the type of game that a player selects to play, the bet amount relative to the minimum bet denomination (e.g., max bet amount for a game can have greater odds than the minimum bet amount), the location at which the game is being played (e.g., game in bar can use payout table with different odds than standalone gaming equipment/table on floor of race track), the type of equipment on which the game is being played (e.g., standalone gaming equipment/table can have greater odds than gaming provided on mobile computing equipment), whether the game is part of a progressive jackpot pool (e.g., electronic touchscreens part of a progressive pool that builds over time until a player gets a particular type of hand(s) can have different odds than electronic touchscreens that are not part of a progressive pool), and/or other factors.

As shown in FIG. 3B, the computer system can discard the fifth card in the card sequence of the hand 316, C15. Since the card C15 is discarded, it may not be used in subsequently dealt sets of cards.

In some implementations, the computer system can apply one or more other rules or algorithms to determine which cards in the card sequence of the hand 316 should be assigned as hit cards and/or initial first and second hand cards.

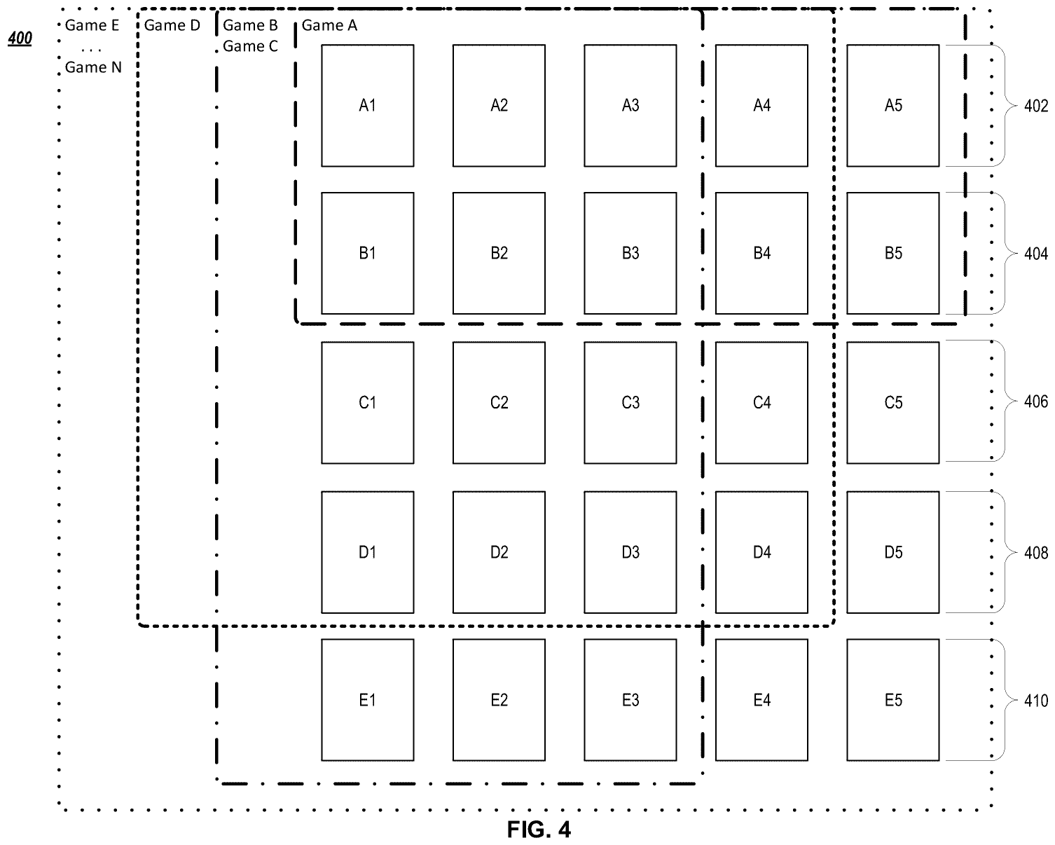

FIG. 4 depicts an example grid 400 of continuously dealt playing cards, which may be used for multiple games including a baccarat described herein. Depicted in FIG. 4 are various example predefined areas, Games A-N, of the grid 400. Physical cards are dealt by a dealer (e.g., dealer 124) into the grid 400, which are then used by an electronic table computing device, such as table computer 126. In some implementations, the grid 400 is constructed based on a sequence of previously dealt and recorded cards. Each of the predefined areas of the grid 400 may be used by the table computer 126 for a particular type of game, Game A, Game B, and so forth, for which the table computer 126 provides gaming outcomes. Moreover, the cards in the grid 400 can be continuously shuffled and/or dealt, as described herein. Sometimes, all of the cards in the grid 400 can be shuffled (all 25 cards). Sets of cards can then be determined along different rows, horizontals, cross-crosses, etc. of the grid 400. This can allow for multiple games to be played in a same screen or interface (e.g., each row can represent a different game that can be played at a same time). Once the cards are shuffled, sets of the shuffled cards can then be transmitted to player devices of the players as described in above. Sometimes, fewer than all 5 sets depicted in the grid 400 can be continuously shuffled and used to generate new sets of cards.

As depicted in FIG. 4, grid 400 includes cards A1-5 in row 402, B1-5 in row 404, C1-5 in row 406, D1-5 in row 408, and E1-5 in row 410. Grid 400 is depicted as including five rows, rows 402-410, and five columns; however, any combination of rows and columns may be employed by the system to determine gaming outcomes.

In the depicted example, the table computer 126 uses cards A1-5 and B1-5 for Game A. The table computer 126 can select cards for gameplay based on card position in the grid 400. The cards A1-5 and B1-5 can also be continuously shuffled for the Game A. A player may be assigned a starting position in the grid 400 or section of the grid assigned to the particular game from which the table computer 126 may select cards. The table computer 126 may select cards sequentially or based on a step sequence (e.g., every other card) from the grid 400, starting from the starting position or based on a draw order assigned to the player or player's hand. For example, A1 may be the starting position and a step sequence of every other card being selected (e.g., A3 would be the second card selected, A5 would be the third cards selected, B2 would be the fourth card selected, and so forth). Other possible algorithms may be used to determine the initial hand and hit cards from the grid 400 for the particular game.

As an illustrative example, for a game of baccarat, cards A1 and A3 can be used to build an initial first hand (e.g., a player hand) and cards A2 and A4 can be used to build an initial second hand (e.g., a banker hand). Card A5 can be discarded and therefore not used in subsequent sets of cards. Card B1 can then be used as a hit card for the first hand and card B2 can be used as a hit card for the second hand, if needed. Cards B3-5 can then be discarded and therefore not used in subsequent sets of cards. One or more other rules and/or variations in card selection can also be used to build the initial first and second hands and/or the hit card(s) in a game of baccarat (e.g., the initial first hand can be selected from amongst the cards A1-5 and the initial second hand can be selected from amongst the cards B1-5).

Once cards for each initial hand are determined, the hands may be presented as initial virtual hands to players on computing devices, such as the devices 104-118 and/or remote devices 136-138, such as in a game of baccarat. The devices may record a respective player's action, such as placing a bet on one or more of the initial hands. The table computer 126 may then use a subset of cards B1-5 or any other sets of cards (e.g., C1-5, D1-5, E1-5) to identify and assign at least one hit card to at least one of the initial first and second hands. The table computer 126 can also reshuffle and/or deal any of the cards in the rows 402-410 and use those cards as hit cards or initial hands cards for players at one or more different times.

As an illustrative example in a game of five-card draw poker, the table computer 126 may replace A2 from a player's hand when discarded during a player's action with card B2, where card B2 was generated in the row 304 at a same or similar time as the player discarded card A2. Alternatively, the table computer 126 may provide a replacement card based on the sequential order of the row. For example, B1 would replace the first card discarded during a player action regardless of the position of the discarded card and so forth. In another alternative implementation, the table computer 126 can use a draw order for the draw cards that is assigned to each player. In a similar manner, the table computer 126 may use each predefined section of grid 400 (e.g., Games A-N) and a draw order, which may be updated between games and/or a series of games, for each predefined section to provide gaming outcomes to the player devices for each type of game supported by the table computer 126.

As an example, assuming that Game A is five-card draw poker, an outcome for each player is determined based on the final five cards in each player's hand, which, as indicated above, may be based on the Game A section of grid 400, different sets of cards that are continuously shuffled in any of the Game A-N sections of the grid 400, a draw order, each player's action, and/or timing of each player's action. In this example, a player with a pair may receive a 1:1 payout, a player with two pairs may receive a 3:2 payout, and a player with a royal flush may receive a 100:1 payout. Odds and outcomes can vary and can be determined using payout tables that correlate a hierarchy of poker hands to different payout odds. For example, the devices 104-118 and 136-138 can permit players to select a type of five-card draw poker game (e.g., Jacks or Better, Tens or Better, Deuces Wild, Bonus Poker, Double Bonus Poker) that they are playing, which can each have different payout tables that provide different odds for different types of hands. In addition to having different gaming outcomes based on the cards that players decide to discard from their initial hand, a variety of other factors can additionally determine the outcome for the player and the payout odds, such as the type of game that a player selects to play, the bet amount relative to the minimum bet denomination (e.g., max bet amount for a game can have greater odds than the minimum bet amount), the location at which the game is being played (e.g., game in bar can use a payout table with different odds than a standalone gaming device/table on the floor of casino), the type of device on which the game is being played (e.g., a standalone gaming device/table can have greater odds than gaming provided on a mobile device), whether the game is part of a progressive jackpot pool (e.g., gaming devices part of a progressive pool that builds overtime until a player gets a particular type of hand(s) can have different odds than gaming devices that are not part of a progressive pool), and/or other factors.

For instance, under a Deuces Wild game, the player may not win the hand unless he/she attains a hand of three of a kind or better (with deuces being wildcards), whereas with the Jacks or Better game, the player may win the hand when he/she attains a pair of jacks or better—the payout table for these games correlates different hands within the hierarchy of poker hands to different outcomes and odds. The gaming outcome for players, and in particular the payout ratio, can depend on a bet amount and/or the location at which the game is being played (e.g., local at the table can have the highest payout, remote location within the gaming facility can have next highest payout, and remote connection outside the gaming facility can have lowest payout—other schemes are also possible). For example, many electronic games can permit a player to bet in increments of a minimum bet amount (e.g., $0.05/hand) up to a maximum bet (e.g., 5× maximum bet for maximum of $0.25/hand). However, the payout for some maximum bets (e.g., 5× bet) can be greater than the multiplier for the maximum bet. For instance, a royal flush may payout at 300:1 for a 1× bet of the minimum bet amount, whereas a royal flush may payout at 3000:1 for a 5× bet of the minimum bet amount, which is a 10× multiplier of the payout for a 5× multiplier of the bet amount.

The devices 104-118 and 136-138, the table computer 126, and/or the computer system 128 can be programmed to provide electronic gaming outcomes to the players based on the cards in grid 400 that are continuously shuffled/dealt; the predefined section of the grid 400 mapped to the current game (e.g., Games A-N), a selection algorithm that determines the initial poker hands and draw cards based on, for example, a draw order; the player discard actions; the poker game selected by each player; and the bet amounts placed by each player. For instance, referring to the example grid 400 depicted in FIG. 4, the selection algorithm for a poker game may designate one of the rows of cards (e.g., row 402 with cards A1-A5) as the initial hand that provided to each player, and from which players can individually select discards. Once players have entered their discard actions, the remaining rows of cards can be dealt (e.g., deal rows 402-410) based on times at which each of the players enter their discard actions. For example, players who discard cards at time=1 can receive cards from the row 404 as replacement cards, players who discard cards at time=2 can receive cards from the row 406, players who discard cards at time=3 can receive cards from the row 408, and players who discard cards at time=4 can receive cards from the row 410. One or more other arrangements for providing cards to the players are possible.

The selection algorithm can use any of a variety of techniques to allocate draw cards from the remaining rows for each of the players, which provide for variation in which draw cards are allocated to each of the players. For example, the selection algorithm can assign different draw orders across some or all of the cards in the remaining rows to the players, such as assigning different orderings of cards within the same row (e.g., each player assigned different order of cards B1-B5 for row 404), assigning different rows of cards to each player (e.g., each player assigned one of rows 404-410), assigning different orderings of cards across different rows (e.g., each player assigned different order of cards B1-E5 for rows 404-410), and/or combinations thereof. The assignments can be automatically determined by the system and/or based on user input/selection. For instance, if the row 302 (cards A1-A5) is used to provide the initial hand, each player may be given the option to select one of the rows 404-410 (example of four remaining rows is depicted, but other numbers of rows from which players can select may be provided-such as two rows, three rows, five rows, etc.) to provide the draw order for the player. The selected row 404-410 for each player may then be (1) continuously shuffled, (2) continuously dealt, and/or (3) used to replace discards for each player using any of a variety of appropriate techniques, such as starting with a first card in the selected row and proceeding sequentially through the row (e.g., replace first discard with B1, next discard with B2, and so on), replacing each discard with a corresponding positioned card within the selected discard row (e.g., replace discard A2 with corresponding card B2 in selected row 404, replace discard A5 with corresponding card A5 in selected row 404), and/or combinations thereof. Other techniques and processes for selecting cards to replace discards are also possible.

The devices 104-118 and 136-138 can be part of a pool of gaming devices that provide progressive jackpots, which are jackpots that build over time until a player gets a particular hand (e.g., royal flush, straight flush). For example, the devices 104-118 can be part of the same progressive pool that builds over time until a player at one of those devices 104-118 gets a particular hand that wins the progressive jackpot, such as obtaining a royal flush. There can be multiple different progressive pools across different groups of gaming devices.

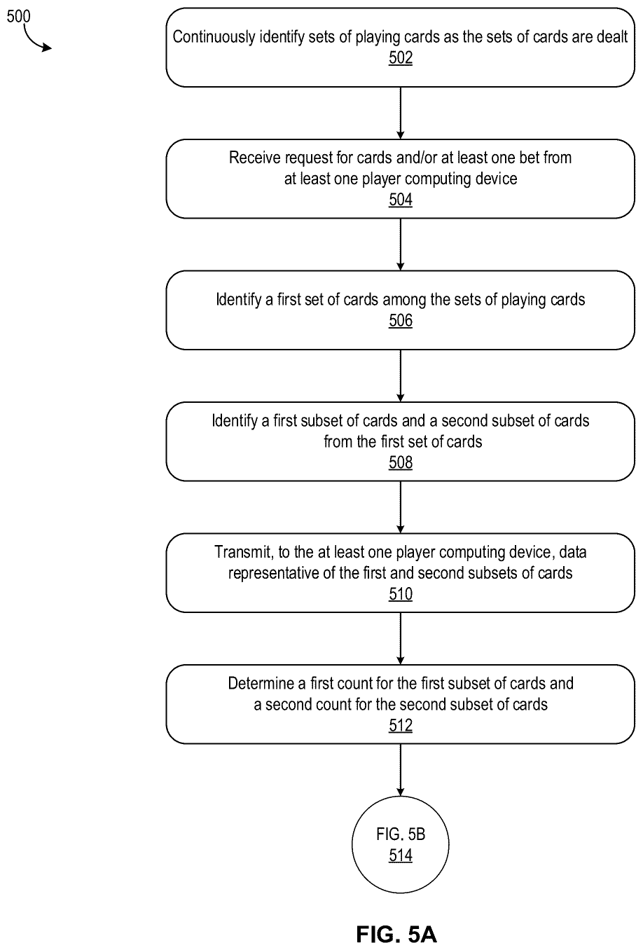

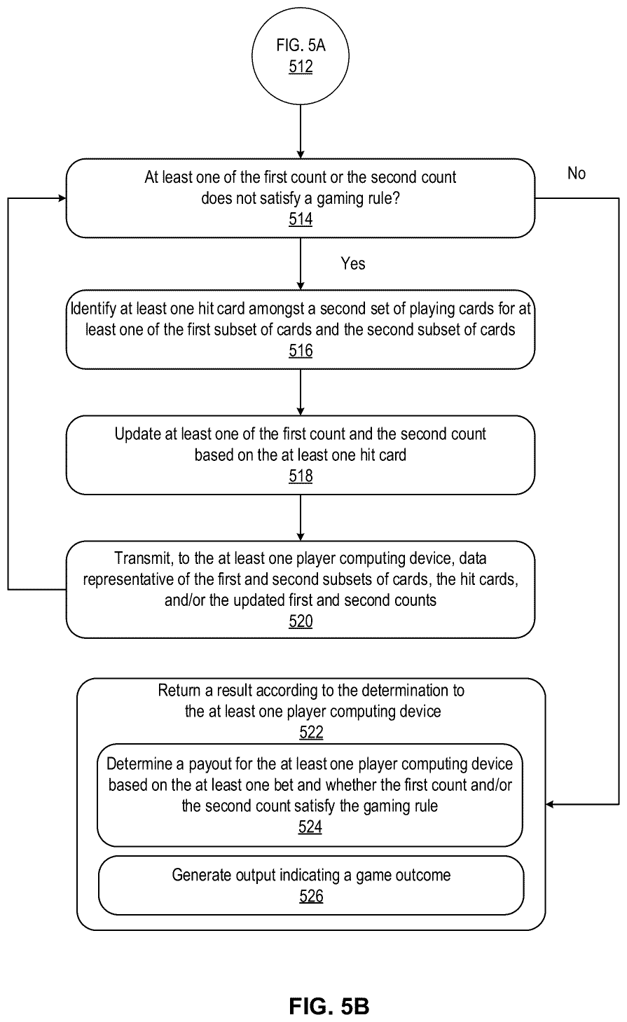

FIGS. 5A-B is a flowchart of an example technique 500 for performing card-based electronic baccarat gaming. The example technique 500 in both FIGS. 5A-B can be performed by any of a variety of appropriate computing equipment and/or systems, such as the table computer 126, the player computing devices 104-118 and 136-138, and the computer system 128. For illustrative purposes, the technique 500 is described from the perspective of a computer system.

Referring to the technique 500 in both FIGS. 5A-B, the computer system continuously identifies sets of playing cards as the sets of cards are dealt (block 502). For example, based on a plurality of sets of playing cards with one set of playing cards being dealt successive to another set of playing cards, the computer system can continuously identify the plurality of sets of playing cards. Physical cards that are going to be continuously shuffled and dealt across the players and their equipment as the initial first and second hands (e.g., first and second subsets of cards) for each player can be detected. As described above, the dealer can continuously shuffle cards for a duration of gameplay. The cards can be shuffled into sets, which are scanned so that the computer system can identify subsets of a set of card to be provided to the player devices 104-118 and 136-138 when the player requests the initial hands. The table computer 126 can detect five cards (e.g., cards C1-C5) that are physically dealt by a dealer from the shoe 120 at a first time using the scanner 122. The scanner 122 can therefore identify each of the physical cards as they are dealt by the dealer at a gaming table.

In block 504, the computer system can receive a request for cards and/or at least one bet, and/or side bet from at least one player computing device. Sometimes, the computer system can determine whether each player is currently in play. For example, the table computer 126 can receive input from the devices 104-118 and 136-138 of the players indicating that the player has joined the game, enrolled, and/or gaming balances have been removed from the players. The table computer 126 can also receive input from the devices 104-118 and 136-138 indicating a request for cards (e.g., initial hands, at least one hit card). The table computer 126 can also determine whether each player is in play based on how much time has passed since the player last provided input or took some action in the game. If, for example, the player's last action was taken during a window of time that exceeds some threshold range (e.g., 10 minutes), then the table computer 126 can determine that the player is not currently in play. The player may, for example, have stepped away from their device 104-118 and 316-138 to do some other activity (e.g., get food, go to the restroom, or altogether stop playing the game).

If the table computer 126 determines that none of the players are in play, then the table computer 126 can merely continue to detect shuffled/dealt sets of cards. If at least one player is in play, then the table computer 126 can determine whether the player is starting a game and requires initial hands, thereby performing block 506. This determination can be made based on information that is received from the devices 104-118 and 136-138. For example, each of the devices 104-118 and 136-138 can determine a stage of gameplay of each player. The devices 104-118 and 136-138 can transmit the determined stage of gameplay to the table computer 126, which the table computer 126 can use to determine whether the player is requesting initial hands. As a result, computational resources can be more efficiently used at the table computer 126 by offloading the stage determination processing to the individual player computing devices 104-118 and 136-138. In other implementations, the table computer 126, the computer system 128, or other suitable computer(s) can determine the stage of gameplay of each player.

The computer system identifies a first set of cards among the sets of playing cards in block 506. For example, based on the request from at least one of the plurality of player computing devices, the computer system can identify the first set of playing cards among the plurality of sets of playing cards being continuously identified. As described herein, the computer system can identify the first set of playing cards having a same timestamp or a timestamp within some threshold amount of time of a timestamp associated with the request.

The computer system identifies a first subset of cards and a second subset of cards from the first set of cards in block 508. The first subset of cards can represent an initial first hand, such as a player hand. The second subset of cards can represent an initial second hand, such as a banker hand. The first subset of cards can include first and third cards in a card sequence in the first set of playing cards. The second subset of cards can include second and fourth cards in the card sequence in the first set of playing cards. A fifth card in the card sequence in the first set of playing cards can be discarded. Therefore, the fifth card may not be used in subsequent sets of playing cards. Refer to FIGS. 1-4 for further discussion about identifying the first and second subsets of cards.

In block 510, the computer system transmits, to the at least one player computing device, data representative of the first and second subsets of cards. The at least one player computing device can output, in response to receiving the data representative of the first and second subsets of cards, graphical representations of the first and second subsets of cards in a GUI display at the player computing device.

The computer system determines a first count for the first subset of cards and a second count for the second subset of cards (block 512). Using gaming rules described above, the computer system can summate card values for each of the first subset of cards and the second subset of cards to determine the respective first count and the respective second count.

The computer system determines whether at least one of the first count and the second count does not satisfy a gaming rule (block 514). At least one of the first count and the second count can satisfy the gaming rule if the respective count is closest to or equals a value of 8 or 9.

If one of the first count and the second count satisfies the gaming rule, the computer system proceeds to block 522, described further below. In other words, the game ends because one of the first and second subsets of cards wins for satisfying the gaming rule.

If either the first count or the second count does not satisfy the gaming rule, the computer system proceeds to block 516. In block 516, the computer system identifies at least one hit card amongst a second set of playing cards for at least one of the first subset of cards and the second subset of cards. The at least one hit card is added to at least one of the first subset of cards and the second subset of cards (e.g., the subset of cards that requires the hit card). Sometimes, as described herein, the hit card can be required for only one hand, such as the first subset of cards. Sometimes, based on the hit card that is assigned to the first subset of cards, another hit card can be assigned to the second subset of cards, or the second hand. The at least one hit card can include a first card and a second card in a card sequence in the second set of playing cards. The second set of playing cards can be continuously dealt and identified at a time that is later than a time at which the first set of playing cards are dealt and identified. The computer system can also discard third, fourth, and fifth cards in the card sequence in the second set of playing cards. The discarded second, third, fourth, and fifth cards may not be used in subsequent sets of the playing cards. As described herein, the first and second sets of playing cards can be different.

The computer system then updates at least one of the first count and the second count based on the at least one hit card (block 518). The computer system can calculate a total value for the first subset of cards or the second subset of cards that receives the at least one hit card using known baccarat gaming rules.

In block 520, the computer system transmits, to the at least one player computing device, data representative of the first and second subsets of cards, the at least one hit card, and/or the updated first and second counts. One or more of the first and second subsets of cards, the at least one hit card, and/or the updated first and second counts can also be transmitted at different times. For example, the first and second subsets of cards can be transmitted to the at least one player computing device before the computer system determines the first and second counts (block 512), before the computer system determines whether the first and/or second counts satisfy the gaming rule (block 514), and/or before the computer system identifies the at least one hit card in block 516. As another example, the computer system may transmit the updated first and second counts later in the technique 500, once the computer system determines gaming outcomes and/or payouts for the at least one player computing device.

Still referring to the technique 500, once the data is transmitted in block 520, the computer system returns to block 514 and determines whether the updated first and/or second counts satisfy the gaming rule. The computer system repeats blocks 514-520 until the gaming rule is satisfied, in which one of the first and second subsets of cards wins or the first and second subsets of cards are tied.

Once the gaming rule is satisfied by one of the updated first and second counts, the computer system proceeds to block 522, in which the computer system returns a result according to the determination in block 514 to the at least one player computing device. As an example, the computer system can determine a payout for the at least one player computing device based on the at least one bet and whether the first count and/or the second count satisfy the gaming rule (block 524). As another example, the computer system can generate output indicating a game outcome (block 526). For example, the computer system can generate output indicating that one of the first and second subsets of cards won the game. Any of the output that is generated can be presented in a GUI display at the at least one player computing device.

The returned result in block 522 can include a variety of information. For example, the result indicates at least one of: (i) the first subset of cards satisfies the gaming rule, (ii) the second subset of cards satisfies the gaming rule, (iii) the first count and the second count are tied. As another example, the result can indicate that the first subset of cards or the second subset of cards wins based on the respective first count or the second count being within a threshold range from a predetermined numeric value. The predetermined numeric value can be a value of 8 or 9, or any other value according to baccarat gaming rules.

The result can also indicate a payout to each of the at least one of the plurality of player computing devices based on the determination of whether at least one of the first count or the second count satisfies the gaming rule. The payout can also be determined for each of the player computing devices based on at least one of the first subset of cards or the second subset of cards winning the game. For example, the computer system can receive, from each of the at least one of the plurality of player computing devices, a bet on the first and second subsets of cards and determine the payout for each of the at least one of the plurality of player computing devices based on the respective bet and the determination of whether at least one of the first count or the second count satisfies the gaming rule. As described herein, the computer system can transmit information to present, in GUI displays of the at least one of the plurality of player computing devices, graphical elements for placing one or more bets on the first and second subsets of cards. The one or more bets include at least one of betting that the first subset of cards wins, the second subset of cards wins, and the first and second subsets of cards are tied. One or more other bets in a game of baccarat can also be offered and placed. Sometimes, as described herein, the computer system can receive, from each of the at least one of the plurality of player computing devices, the bet before identifying the first and second subsets of cards. Sometimes, the computer system can receive, from each of the at least one of the plurality of player computing devices, the bet before transmitting, to each of the at least one of the plurality of player computing devices, the data representative of the first and second subsets of cards. Sometimes, the computer system can start a timer for a threshold period of time during which the computer system receives bets from the at least one of the plurality of player computing devices and then based on the threshold period of time expiring, stop the timer and transmit, to each of the at least one of the plurality of player computing devices, the data representative of the first and second subsets of cards.

The at least one player computing device can present the first and second subsets of cards (e.g., the first and second hands) on the GUI display of the at least one player computing device to the player along with selectable options through which the players can designate what actions they would like to take. Players that start the game at or around the same time can each receive and be presented with the same initial first and second hands, but can make individual game decisions so far as bets to be placed. The players can also continue to play the game at their desired paces, and therefore may receive subsequent subsets of sets of cards that are generated at different times. Players can employ different gameplay strategies, which may be dictated in part based on the baccarat gaming rules that are applied. Their gameplay strategies can influence how quickly they play the game and which sets of cards they receive, without impacting a gameplay speed of other players.

In some implementations of the technique 500, additional processes can be performed. For example, the player computing devices/equipment that are going to play a game of baccarat can be enrolled and debits for playing the game can be taken against gaming balances for each player. For example, the devices 104-118 and 136-138 can enroll with the table computer 126 and/or the computer system 128 to play in a next game of baccarat on the table 102, and a debit/ante to play the game can be taken from each player's virtual gaming balance that is maintained on devices 104-118 and 136-138, the table computer 126, and/or the computer system 128. The players can be enrolled at different times, based on whenever each of the new players desire to join or start the game.

Enrolling a new player can include, for example, the player either creating or providing player account information via the devices 104-118 and 136-138. For example, a new player may create a new player account by physically and/or electronically depositing money via the devices 104-118 and 136-138, the table computer 126, and/or the computer system 128 (e.g., feeding physical money into a bill reader that is part of/connected to the devices 104-118, providing credit/debit card information, providing bank account information). A unique account identifier can be created and funds deposited into the account can be credited to the account by the table computer 126 and/or the computer system 128, for example, as part of a ticket-in ticket-out (TITO) system. Players with preexisting accounts can provide account information via the devices 104-118 and 136-138 through one or more input mechanisms, such as through a physical ticket reader (e.g., ticket reader to read unique account identifier encoded on the ticket), through a player card reader (e.g., magnetic strip reader, RFID reader), through input of a username and password, and/or through other input mechanisms. New players can be prompted through one or more selectable options to designate a type of poker game they want to play and/or to designate a bet amount for the next baccarat game.

Enrolling existing players can include receiving input from the players at any point during the game. The time at which the player provides input to start a game can be used to determine which initial hands the player receives, as described above. Therefore, the game can have continuous progression and players that are currently playing or wanting to start the game do not need to wait for other players to make a decision or otherwise opt in to join the game.

In some implementations, however, enrolling existing players in a next baccarat game can include players either providing or not providing particular types of input within a threshold amount of time for the next game to start. For example, in some instances players may opt-in to play a next game, and can be provided with a time-limited selectable option to opt-in to game play for a next baccarat game at a table where the player just finished a game. Failure to select the option within a threshold amount of time can cause the player to sit-out the next game. In other instances, player may have to opt-out to avoid repeating his/her bet in a next stage of gameplay of a current game of baccarat, and can be provided with a time-limited selectable option to opt-out of gameplay. Failure to select the option within the threshold amount of time can cause the player to be automatically enrolled in the next stage of gameplay at the same bet amount. Other opt-in and opt-out options are also possible, such as a player designating a bet amount for a next baccarat stage of gameplay or new game entirely as an implicit opt-in for a game. Existing players can additionally be provided with selectable options between stages of gameplay to change the type of game that they are playing between and/or to change their bet amount.

In another example, players can similarly switch between tables upon completing a game (switch to a new table after the end of one iteration of the technique 500 and before starting another iteration of the technique 500). For example, a player can designate that he/she is ready to start another game and can select an option to be switched to another table that is starting a new game, in response to which the player electronic touchscreen can be switched to gaming with cards dealt on another table. Other options for switching between tables are also possible, such as providing input (e.g., designating a bet for the new game), the user designating that he/she is ready to play a new game, the user designating that he/she wants to be moved to another table, and/or other options.

The system 100 and, particularly, the shoe 120 can be specifically adapted to provide for efficient and repeated gaming, for example, using the technique 500. For example, the shoe 120 can be a six-deck continuous shuffle shoe such that multiple decks of cards can be shuffled together and dealt from the shoe 120. In alternative examples, the shoe 120 can include multiple decks other than six. The systems according to implementation of the present disclosure provide gaming that are amenable to using multiple decks of cards that are all shuffled together and dealt from the shoe 120, as with other types of card-based gaming, like blackjack. For example, the six-deck continuous shuffle shoe 120 in the system described herein can provide for more efficient repeated game play (e.g., no need to shuffle between each game), without significantly reducing player odds, which may be more appealing to players than with conventional baccarat equipment. To maintain the same odds that are provided with conventional electronic baccarat equipment while using physical cards in a configuration that allows for efficient and repeated game play, the shoe 120 and shuffling systems (e.g., automatic shuffling machines, human shufflers) can be adapted in a couple different ways. As mentioned above, the shoe 120 can be a six-deck continuous shuffle shoe. In another example, automatic shuffling machines can be adapted to receive multiple decks of cards, with each deck of cards being separated by a physical delimiter (e.g., plastic card separator, change in card orientation). The automatic shuffling machines can then shuffle each deck separately and output a stack of randomly shuffled decks, where each deck is separated by a physical delimiter. When dealing the cards from the shoe 120, the dealer 124 can deal a preset number of cards from the first deck in the shoe 120 for the first game and then discard the remainder of the cards from the first deck (at the conclusion of the first game), then deal a preset number of cards from the second deck in the shoe 120 and then discard the remainder of the cards from the second deck, and so on until all of the decks have been dealt. By doing this, the dealer 124 can deal multiple games without having to shuffle or obtain shuffled cards for each game, which can increase the pace of gameplay, and without having to resort to using multiple decks of cards, which could lower player odds for the game.

In another example, automatic shufflers can be adapted to output a number of cards from each deck for placement in the shoe 120 (instead of the entirety of each deck) and then the dealer 124 can simply and continuously deal games using the technique 500. By doing this, the gameplay can be made even more efficient by not requiring the dealer 124 to remove the remainder of the deck before starting a next game. This can present potential problems with keeping decks of cards separate from each other, which can be accomplished by marking cards with a unique identifier for the deck to which the card belongs (in addition to each card in a deck being marked with an identifier for the card (suit, card number)). An automatic shuffler can be programmed to receive a group of cards from mixed decks, to separate the cards into their respective decks based on the deck identifiers, and then to shuffle each deck separately from the other decks. If a deck is found to be incomplete after receiving all available cards, the cards from that deck can be discarded as being part of an incomplete deck. By doing this, the dealer 124 can more efficiently deal multiple games without having to shuffle or obtain shuffled cards for each game, which can increase the pace of gameplay, and without having to resort to using multiple decks of cards, which could lower player odds for the game.

Automatic shufflers and the system 100 can additionally and/or alternatively be adapted to continuously shuffle and use decks with greater than 52 cards, such as decks that include one or more jokers. Each table can include one or more automatic shufflers, such as tables having two, three, or more automatic shufflers to concurrently shuffle multiple decks of cards. Shufflers can be configured to output cards in groups, such as outputting sets of five cards together that can be used as the initial hands and the hit cards. The automatic shufflers can accommodate one or more decks at a time.

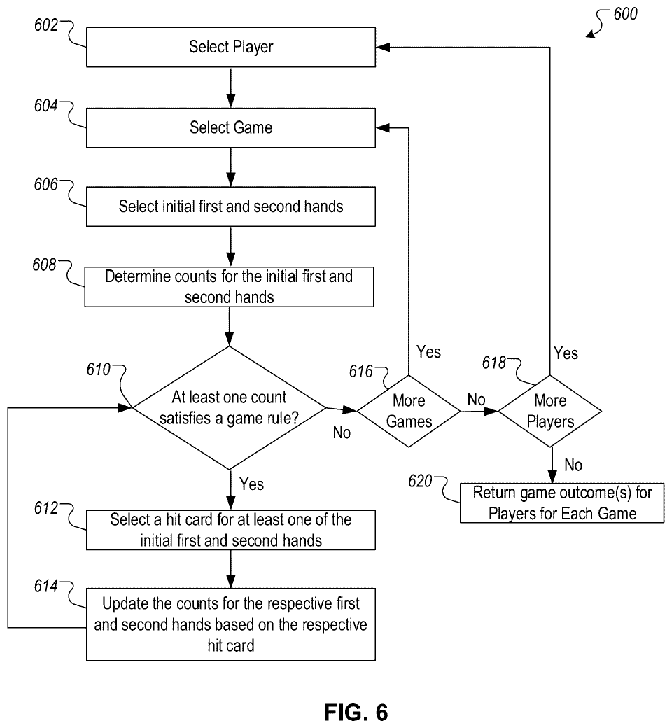

FIG. 6 is a flowchart of another example technique 600 for determining gaming outcomes for multiple games that are simultaneously played as cards are being continuously dealt. The example technique 600 can be performed by any of a variety of appropriate computing devices and/or systems, such as the table computer 126, the computing devices 104-118 and 136-138, and the computer system 128. The technique 600 can be performed, for example, as part of the technique 500 (e.g., refer to FIGS. 5A-B).

For games such as baccarat, the cards selected for initial first and second hands from a grid can be viewed as each having a position that is established based on an order in which the cards were dealt. In the example of the grid 400 in FIG. 4, cards A1 and A3 can be used to build the initial first hand and cards A2 and A4 can be used to build the initial second hand. When hit cards are required, they can be drawn from another grid, such as from cards B1-5 that are dealt after cards A1-5. The starting position in the grid for reading the hit cards can be a first sequential card that is drawn or dealt in that grid. For example, in the grid 400 in FIG. 4, card B1 can be a first hit card drawn for either the initial first or second hands. Card B2 can be a second hit card drawn for initial hand that did not receive the card B1, assuming according to baccarat gaming rules, the initial hand that did not receive the card B1 should also receive a hit card.

For games that require draw cards (e.g., draw poker), the cards selected for a player's initial hand from a grid can be viewed as each having a position that is established based on the order in which the draw cards were selected (e.g., the cards order in the grid) or based on an order assigned to the cards in the initial hand. When draw cards are read from the same grid or grid section as the initial cards, the starting position in the grid for reading the draw card can be the next sequential card after the last card selected for the initial hand. When the draw cards are read from another grid than the cards read for the initial hand, the starting position in the other grid for reading the draw card can be the first card in the other grid or section of the other grid allocated to the particular game for which the cards are being selected. Draw cards are selected by sequentially progressing through the remaining cards in the grid or grid section to fill the open spots in each player's hand resulting from player discards from the initial hand. For example, referring to grid 400 in FIG. 4, if cards A1-5 were used as players' initial hands, the next sequential positon would be B1. A first player who discarded two cards at a first time, will receive the next two sequential cards in the grid, B and B2. A second player who discarded three cards at the same time will receive the cards B1, B2, and B3. On the other hand, if the second player discarded three cards at a different time, then the second player can receive cards that were dealt in the grid at the different time. For example, the cards C1, C2, and C3 can be dealt at the same time or around the same time that the second player discarded three cards. Thus, the second player can receive the cards C1, C2, and C3 instead of the cards B1, B2, and B3, which were dealt at a different time.

As part of the technique 600, a player who is playing (either physically or virtually) at a table is selected (block 602). A game played by the selected player is selected (block 604), such as baccarat, followed by selecting (block 606) initial first and second hands for the particular selected game and player, as described above. Counts are determined for each of the initial first and second hands (block 608), and a determination is made whether at least one of the counts satisfies a baccarat game rule (block 610). If the baccarat game rule is not satisfied, one of the hands has won the current game and block 616 can be performed, as described further below.

If the baccarat game rule is satisfied, then neither hands may be a winning hand, and therefore a hit card may be identified and assigned to one or both of the first and second hands. Accordingly, a hit card for at least one of the initial first and second hands is selected (block 612) and the count(s) for the respective first and/or second hands is updated based on a card value of the respective hit card (block 614). Another determination can be made of whether at least one of the counts satisfies the game rule (block 610). If neither of the counts satisfy the game rule, then the first and second hands may be tied or one of the first and second hands wins the current game. Accordingly, block 616 can be performed, as described below. The blocks 610-614 can be repeated until the current game naturally ends (e.g., according to baccarat game rules, one of the hands is a winning hand, the hands are tied).

Once the current game of baccarat ends, in block 616, a check is done as to whether the selected player is playing more than one game. If there are more games for that player, then blocks 604-614 are repeated for each game. In other words, for every game of baccarat that the player is currently playing, initial hands can be established and hit cards can be determined and assigned to either of the initial hands.

A check (block 618) is also done as to whether there are more players physically and/or virtually playing at the table who have not yet had their initial first and second hands assigned and/or hit cards determined and assigned (blocks 606 and 612). If there are more players, then the blocks 602-616 are repeated for each player. Once the blocks 602-616 are performed for all the players playing at the table, gaming outcomes for the players for each game can be determined and returned (block 620).

Sometimes, any one or more blocks in the technique 600 can be performed simultaneously. For example, one or more of the blocks 604-616 can be simultaneously performed for each player playing one or more games at a same or similar time. Sometimes, one or more other rows in the grid 400 can be used to provide initial hands and/or hit cards to players that are at different stages of gameplay at one or more different times. Thus, the entire grid 400 may be used for a game of baccarat. In such an implementation, as described herein, the cards in row A1-5 may be used as initial hands for a player and one or more hit cards can be selected sequentially outside of the Game A section in the grid 400.

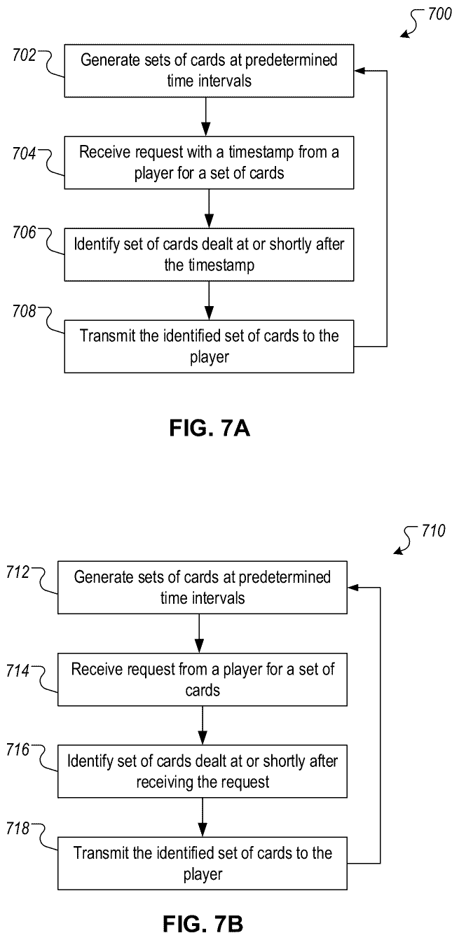

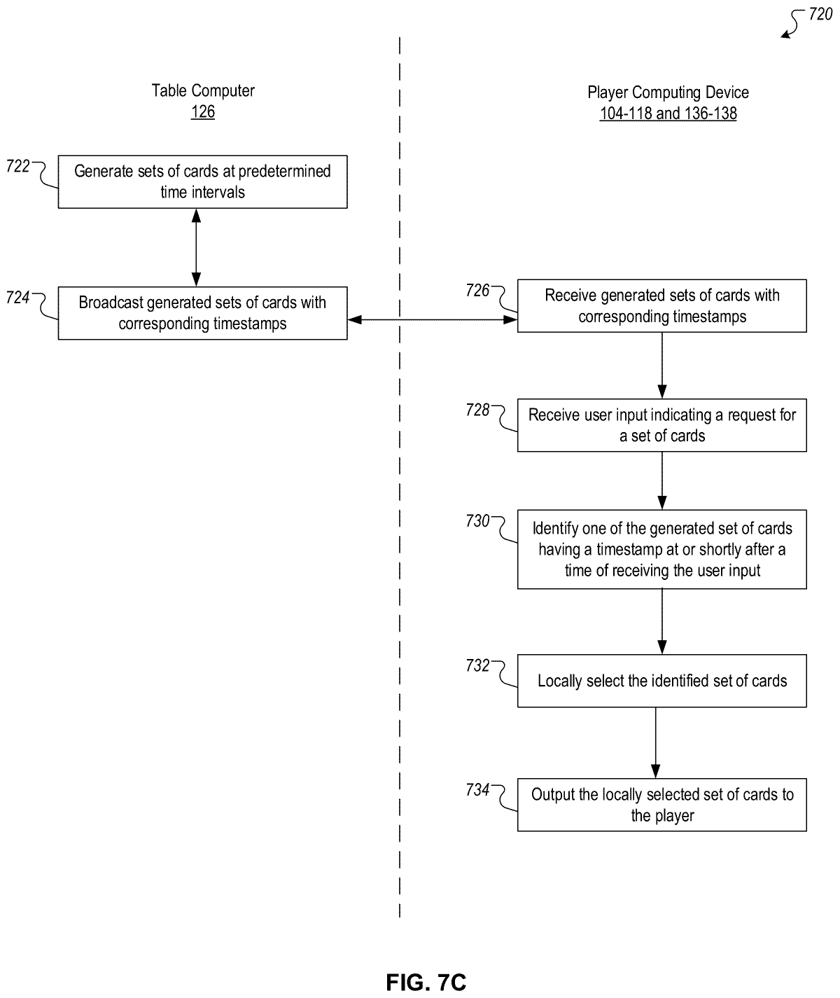

FIGS. 7A-C are flowcharts of example techniques 700, 710, and 720 for transmitting sets of cards to player computing devices. The techniques 700, 710, and 720 can be used to maximize output in terms of numbers of cards being played in a period of time. The example techniques 700, 710, and 720 can be performed by any of a variety of appropriate computing devices and/or systems, such as the table computer 126, the computing devices 104-118 and 136-138, and the computer system 128. The techniques 700, 710, and 720 can be performed, for example, as part of the techniques 500, and/or 600 (e.g., refer to FIGS. 5-6).

Referring to the technique 700 in FIG. 7A, sets of cards can be generated at predetermined time intervals (block 702). As described above in reference to FIGS. 1-3, the dealer (such as the dealer 124) can continuously deal sets of cards at the dealer's desired pace (e.g., as quickly as the dealer can deal and scan sets of cards). Each set of cards that is generated can include a timestamp indicating a time at which the set is generated and/or scanned by the scanner 122. Sometimes, the timestamp can be a relative timing that takes into consideration a time when the cards are physically dealt and a time at which the cards are scanned and registered by the table computer 126. Sets of cards can be continuously generated and scanned throughout the technique 700.

The table computer 126 can receive a request from a player device for a set of cards (e.g., initial first and second hands in baccarat, one or more hit cards) (block 704). The request can include a timestamp. The timestamp can indicate a time at which the player performed some action in the game, such as selecting an option to begin a new game, placing a bet on either initial first and second hands, or requesting one or more hit cards. The timestamp can also indicate a time at which the request for the set of cards is transmitted and/or received by the table computer 126.

The table computer 126 can then identify a set of cards that were dealt (block 702) at or shortly after the timestamp in the request (block 706). For example, the table computer 126 can determine which set of cards has been dealt within a predetermined threshold time range from the timestamp in the request. The table computer 126 can compare a timestamp of each set of dealt cards with the timestamp in the request. A set of cards having the same timestamp can be selected (block 706). In some implementations, a set of cards having a timestamp within a threshold amount of time after the timestamp in the request can be identified. In other implementations, a set of cards having a timestamp within a threshold amount of time before the timestamp in the request can be identified. In yet some implementations, if the timestamp in the request falls within the timestamps of a first set of cards and a second set of cards, the second set of cards can be selected to enhance game security (e.g., to ensure that no player has an upper hand or advantage on other players in the game). If game security would be unaffected by selection of a set of cards, then the first set of cards can be selected in order to increase pace of gameplay.

Moreover, in some implementations, selection of a set of cards can be based on decisions made based on timing of decisions that are made by a player, rather than the timestamp in the request. For example, if the player makes a decision prior to a fifth card in a current set of cards being drawn, then the player would receive at least one card from that current set of five cards. If the player makes a decision after the timestamp of the fifth card in the current set of cards that are being drawn, then the player would receive at least one card from a next set of five cards that are drawn by the dealer. After the set of cards are selected in block 706, the table computer 126 can transmit the identified set of cards to the player (block 708).

Referring to the technique 710 in FIG. 7B, sets of cards can be generated at predetermined time intervals (block 712). Refer to block 702 in the technique 700 depicted in FIG. 7A. The table computer 126 can receive a request from a player device for a set of cards (block 714). The request may not include a timestamp. Accordingly, unlike the technique 700, the table computer 126 can identify a set of cards that were dealt at or shortly after receiving the request (block 716). The table computer 126 can then transmit the identified set of cards (or a subset of the identified set of cards) to the player's device (block 718).

Referring to the technique 720 in FIG. 7C, sets of cards can be generated at predetermined time intervals (block 722). As described in reference to FIG. 7A, the dealer can continuously deal sets of cards, which can be scanned by the scanner and detected or otherwise registered by the table computer 126. The table computer 126 can then broadcast the sets of cards with corresponding timestamps (block 724). The table computer 126 can broadcast each set of cards as they are generated. Other times, the table computer 126 can broadcast sets of cards in batches (e.g., broadcast 2 sets of cards at a time, where each set has a different timestamp indicating when they were generated). The sets can be broadcasted to all player computing devices 104-118 and 136-138, regardless of whether players are actually playing the games at such devices. Sometimes, the sets can be broadcasted only to those devices 104-118 and 136-138 where players are currently playing the game. For example, the table computer 126 can receive notifications from the devices 104-118 an 136-138 that indicate that a player has started a game or taken some action in a game. The table computer 126 can then broadcast the sets of cards to only those devices.

The player computing devices 104-118 and 136-138 can receive the generated sets of cards with their corresponding timestamps (block 726). The devices 104-118 and 136-138 can also receive user input indicating a request for a set of cards (block 728). The user input can be some action that is taken in the game by the player. For example, the player can select an option to start a game, which can be user input indicating that player user needs initial first and second hands of cards. The player can also place one or more bets on current initial first and second hands, which can be user input indicating that gaming outcomes may be determined and/or hit cards may be identified and assigned.

Sometimes, the user input can be received before one or more of the generated sets of cards are received. Sometimes, the user input can be received at a same time as one or more of the generated sets of cards. Moreover, as described above, the devices 104-118 and 136-138 can continuously receive the generated sets of cards, regardless of when the devices 104-118 and 136-138 receive user input indicating a request for a set of cards.

The devices 104-118 and 136-138 can identify one of the generated sets of cards having a timestamp that is at or shortly after a time that the devices received the user input (block 730). For example, the devices 104-118 and 136-138 can temporarily store the sets of cards that are broadcasted by the table computer 126 in 724 and received in 726. The devices 104-118 can look at the timestamps for each of the sets of cards in temporary storage and determine which timestamp falls within some predetermined threshold range of time from the time of the request for a set of cards. A set of cards that were dealt at a same time as the request can be identified. A set of cards that were dealt within a threshold amount of time after the request was received can be identified. In some implementations, a set of cards that were dealt within a threshold amount of time before the request was received can be identified.

The devices 104-118 and 136-138 can then locally select the identified set of cards (block 732). Performing blocks 730-732 at each of the devices 104-118 and 136-138 can be advantageous to more efficiently utilize computational resources, especially at the table computer 126. The table computer 126 can then operate more efficiently and quickly since it does not have to determine, for each player, which set of cards each device 104-118 and 136-138 should receive.

Finally, the devices 104-118 and 136-138 can output the locally selected set of cards (or a subset of the locally selected set of cards) to the player (block 734). The player can then take some action in the game based on their updated hand, and the blocks 722-734 can be repeated until the game ends/one of the first and second hands wins.

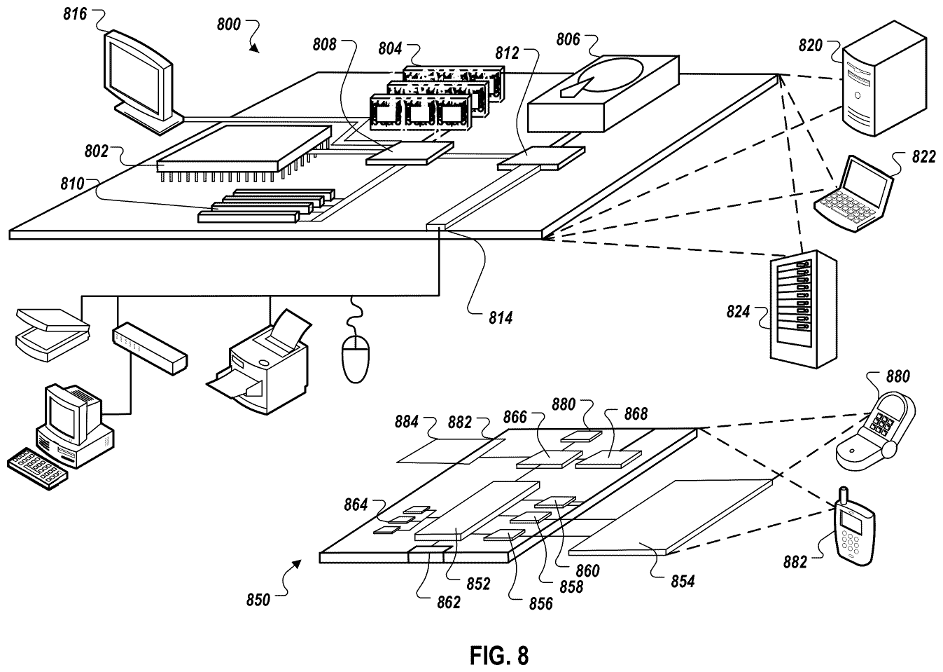

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation- and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. An electronic gaming system using common playing cards, the system comprising:
a plurality of player computing devices that are configured to provide individualized gaming interfaces for a plurality of players; and
a gaming computing device that is in communication with the plurality of player computing devices, the gaming computing device configured to:
based on a plurality of sets of playing cards with one set of playing cards being dealt successive to another set of playing cards, continuously identify the plurality of sets of playing cards;
based on a request from at least one of the plurality of player computing devices, identify a first set of playing cards among the plurality of sets of playing cards being continuously identified;
identify, among the first set of playing cards, a first subset of cards and a second subset of cards;
transmit, to each of the at least one of the plurality of player computing devices, data representative of the first and second subsets of cards;
determine (i) a first count for the first subset of cards and (ii) a second count for the second subset of cards;
determine whether at least one of the first count or the second count satisfies a gaming rule; and
return, to each of the at least one of the plurality of player computing devices, a result, the result including a determination of whether at least one of the first count or the second count satisfies the gaming rule.

2. The electronic gaming system of claim 1, further comprising:
a plurality of physical playing cards that are physically dealt by a dealer;
a scanner that is configured to identify each of the playing cards as they are dealt by the dealer, wherein the scanner is in communication with the gaming computing device; and
a plurality of gaming tables, wherein each of the plurality of gaming tables allows the dealer to deal the physical playing cards,
wherein the scanner is configured to read one or more of the physical playing cards for the gaming table.

3. The electronic gaming system of claim 2, wherein at least one of the plurality of player computing devices is physically located at at least one of the plurality of gaming tables.

4. The electronic gaming system of claim 2, wherein at least one of the plurality of player computing devices is physically remote from a location of at least one of the plurality of gaming tables.

5. The electronic gaming system of claim 1, wherein the first subset of cards represents a first player hand and the second subset of cards represents a second player hand.

6. The electronic gaming system of claim 1, wherein the result includes a payout to each of the at least one of the plurality of player computing devices, wherein the gaming computing device is further configured to:
receive, from each of the at least one of the plurality of player computing devices, a bet on the first and second subsets of cards; and
determine the payout for each of the at least one of the plurality of player computing devices based on the respective bet and the determination of whether at least one of the first count or the second count satisfies the gaming rule.

7. The electronic gaming system of claim 6, wherein the gaming computing device is further configured to transmit information to present, in graphical user interface (GUI) displays of the at least one of the plurality of player computing devices, graphical elements for placing one or more bets on the first and second subsets of cards.

8. The electronic gaming system of claim 7, wherein the one or more bets include at least one of betting that the first subset of cards wins, the second subset of cards wins, and the first and second subsets of cards are tied.

9. The electronic gaming system of claim 6, wherein the gaming computing device is configured to receive, from each of the at least one of the plurality of player computing devices, the bet before identifying the first and second subsets of cards.

10. The electronic gaming system of claim 6, wherein the gaming computing device is configured to receive, from each of the at least one of the plurality of player computing devices, the bet before transmitting, to each of the at least one of the plurality of player computing devices, the data representative of the first and second subsets of cards.

11. The electronic gaming system of claim 6, wherein the gaming computing device is further configured to:
start a timer for a threshold period of time during which the gaming computing device receives bets from the at least one of the plurality of player computing devices; and
based on the threshold period of time expiring, stop the timer and transmit, to each of the at least one of the plurality of player computing devices, the data representative of the first and second subsets of cards.

12. The electronic gaming system of claim 1, wherein the gaming computing device is further configured to, based on at least one of the first count or the second count satisfying the gaming rule:
identify, among a second set of playing cards among the plurality of sets of playing cards, at least one hit card, wherein the at least one hit card is added to at least one of the first subset of cards and the second subset of cards; and
transmit, to each of the at least one of the plurality of player computing devices, data representative of the at least one hit card.

13. The electronic gaming system of claim 12, wherein the gaming computing device is further configured to:
update, according to the gaming rule, at least one of the first count or the second count of the at least one of the first subset of cards and the second subset of cards that is assigned the at least one hit card; and
determine whether the at least one of the updated first count or the updated second count satisfies the gaming rule.

14. The electronic gaming system of claim 12, wherein the playing cards are physical playing cards and the gaming computing device is configured to translate the first set of playing cards into a first set of electronic cards at a first time and translate the second set of playing cards into a second set of electronic cards at a second time, wherein the first time is before the second time.

15. The electronic gaming system of claim 12, wherein the at least one hit card includes a first card and a second card in a card sequence in the second set of playing cards.

16. The electronic gaming system of claim 12, wherein the first set of playing cards is different than the second set of playing cards.

17. The electronic gaming system of claim 16, wherein the gaming computing device is further configured to return results indicating that the first subset of cards or the second subset of cards wins based on the respective first count or the second count being within a threshold range from a predetermined numeric value.

18. The electronic gaming system of claim 1, wherein:
the first subset of cards includes first and third cards in a card sequence in the first set of playing cards, and
the second subset of cards includes second and fourth cards in the card sequence in the first set of playing cards.

19. The electronic gaming system of claim 1, wherein the gaming rule includes at least one rule for playing a game of baccarat.

20. The electronic gaming system of claim 1, wherein the gaming computing device is further configured to provide, in GUI displays of the at least one of the plurality of player computing devices, selectable options to play multiple different games simultaneously with the first or second subsets of cards.
